(19) United States
(12) Patent Application Publication
(10) Pub. No.: US 2015/0170288 A1
(43) Pub. Date: Jun. 18, 2015

(54) SYSTEMS AND METHODS FOR WEATHER EVENT-BASED INSURANCE CLAIM HANDLING

(71) Applicant: The Travelers Indemnity Company, Hartford, CT (US)

(72) Inventors: Brian N. Harton, Hartford, CT (US); Jared C. Krechko, Manchester, CT (US); Stefanie M. Zacchera, Glastonbury, CT (US); Keith M. Janson, Avon, CT (US); Adam Sobek, Litchfield, CT (US)

(73) Assignee: The Travelers Indemnity Company, Hartford, CT (US)

(21) Appl. No.: 14/280,892

(22) Filed: May 19, 2014

Related U.S. Application Data
(60) Provisional application No. 61/915,121, filed on Dec. 12, 2013.

(51) Int. Cl. G06Q 40/08

(52) U.S. Cl. CPC G06Q 40/08

(57) ABSTRACT

Systems, apparatus, interfaces, methods, and articles of manufacture that provide for insurance claims handling, underwriting, and risk assessment applications utilizing georeferenced weather event.

### CROSS-REFERENCE TO RELATED APPLICATIONS

The present application claims benefit and priority under 35 U.S.C. §119(e) to, and is a non-provisional of, U.S. Provisional Patent Application No. 61/915,121 filed on Dec. 12, 2013 and titled “SYSTEMS AND METHODS FOR WEATHER EVENT-BASED INSURANCE PROCESSING”, the entirety of which is hereby incorporated by reference herein.

### BACKGROUND

Weather events are increasingly the cause of mass occurrences of insurance losses. It is often unclear, however, which insurance claims are attributable to a particular event. As a result, claims are often paid for losses that may not have been sustained during a period when an insurance policy was in force, or claims/losses may otherwise be improperly characterized—which itself may cause premiums, deductibles, and/or other insurance parameters to be improperly adjusted. Such errors may result in decreased insurance company profits and/or improper insurance coverage for consumers.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a flow diagram of a method according to some embodiments;

FIG. 5 is a diagram of an example data storage structure according to some embodiments;

FIG. 6 is a diagram of an example interface according to some embodiments;

FIG. 7 is a block diagram of a data layer according to some embodiments;

FIG. 8 is a perspective diagram of a system according to some embodiments;

FIG. 9 is a perspective diagram of a system according to some embodiments;

FIG. 10 is a block diagram of an apparatus according to some embodiments; and

FIG. 11A, FIG. 11B, FIG. 11C, FIG. 11D, and FIG. 11E are perspective diagrams of exemplary data storage devices according to some embodiments.

### DETAILED DESCRIPTION

Embodiments described herein are descriptive of systems, apparatus, methods, interfaces, and articles of manufacture for weather event-based insurance claim handling. Geospatial data may be utilized, for example, to cross-reference or compare loss information (e.g., insurance claims) to potentially related weather data having occurred (or having a likelihood of having occurred) at a particular location. In some embodiments, claim information (e.g., location and/or loss type or description) may be analyzed and/or processed with reference to historic weather data (such as radar data) to determine a likelihood of a loss having been caused by one or more particular storm events. According to some embodiments, an interface may be provided that permits graphical and/or visual analysis of weather event-based claim data.

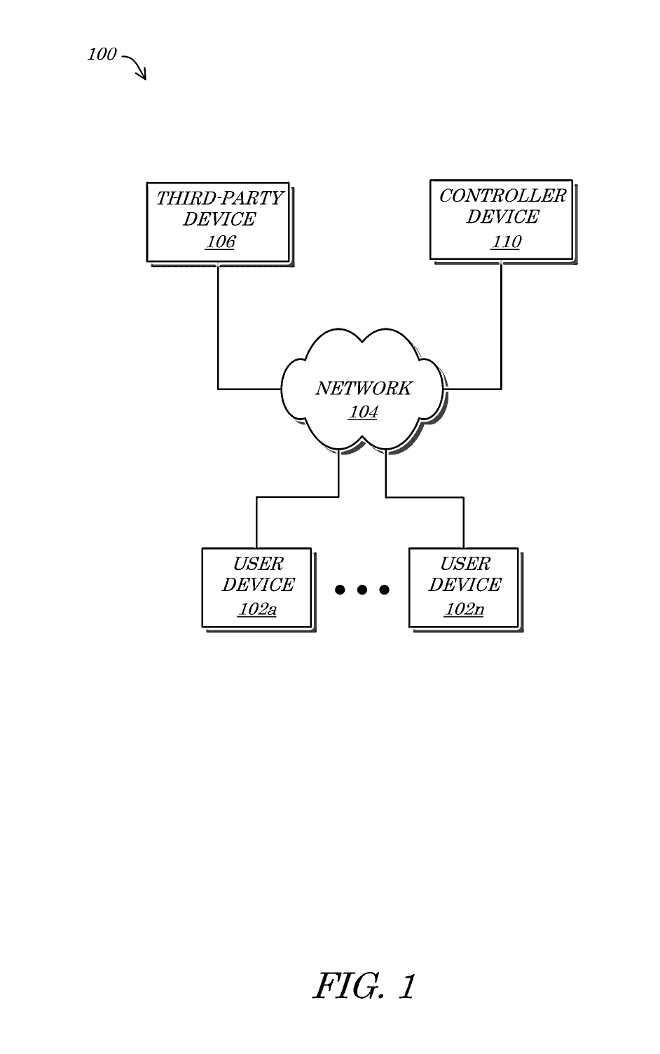

Referring initially to FIG. 1, a block diagram of a system 100 according to some embodiments is shown. In some embodiments, the system 100 may comprise a plurality of user devices 102a-n, a network 104, a third-party device 106, and/or a controller device 110. As depicted in FIG. 1, any or all of the devices 102a-n, 106, 110 (or any combinations thereof) may be in communication via the network 104. In some embodiments, the system 100 may be utilized to provide (and/or receive) customer data, geospatial data, weather data, claim data, and/or other data or metrics. The controller device 110 may, for example, interface with one or more of the user devices 102a-n and/or the third-party device 106 to acquire, gather, aggregate, process, and/or utilize geospatial data, weather data, and/or claim data and/or other data or metrics in accordance with embodiments described herein.

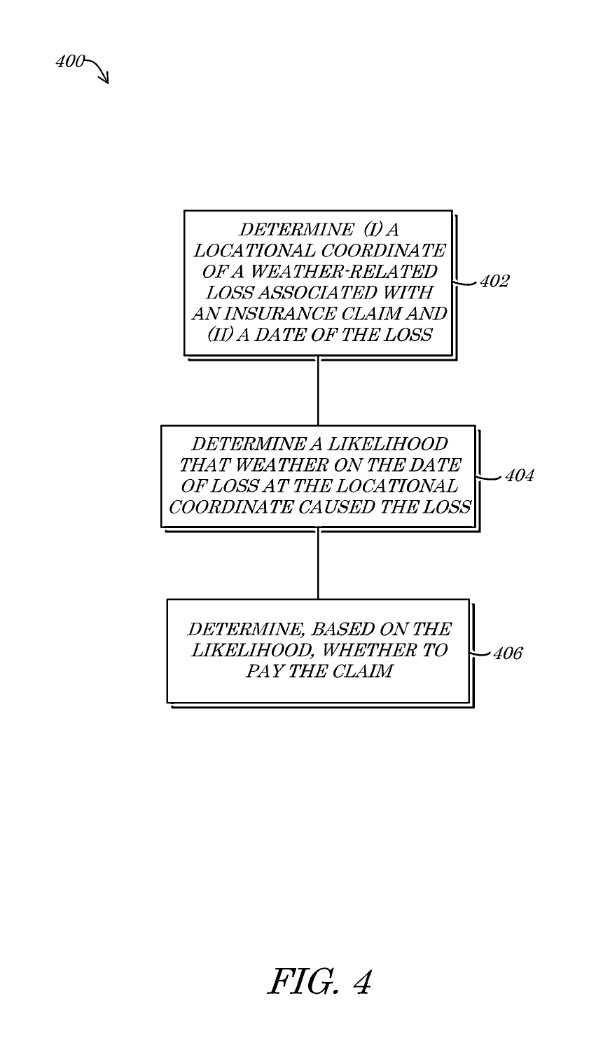

Fewer or more components 102a-n, 104, 106, 110 and/or various configurations of the depicted components 102a-n, 104, 106, 110 may be included in the system 100 without deviating from the scope of embodiments described herein. In some embodiments, the components 102a-n, 104, 106, 110 may be similar in configuration and/or functionality to similarly named and/or numbered components as described herein. In some embodiments, the system 100 (and/or portion thereof) may comprise a claim handling program, system, and/or platform programmed and/or otherwise configured to execute, conduct, and/or facilitate the method 400 of FIG. 4 and/or portions thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., claim adjuster and/or handler and/or underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as claim handlers, field agents, underwriters, account managers, agents/brokers, customer service representatives, data acquisition partners and/or consultants or service providers, and/or underwriting product customers. According to some embodiments, the user devices 102a-n may communicate with the controller device 110 via the network 104, such as to conduct claim handling inquiries and/or processes utilizing geospatial and/or weather data as described herein.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more sensors configured and/or coupled to sense, measure, calculate, and/or otherwise process or determine geospatial, weather, and/or claim data. In some embodiments, such sensor data may be provided to the controller device 110, such as for utilization of the geospatial, weather, and/or claim data in claim handling, pricing, risk assessment, line and/or limit setting, quoting, and/or selling or re-selling of an underwriting product.

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller device 110, the user devices 102a-n, and/or the third-party device 106. In some embodiments, the network 104 may comprise direct communications links between any or all of the components 102a-n, 106, 110 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110 of the system 100. The network 104 may comprise one or more cellular telephone networks with communication links between the user devices 102a-n and the controller device 110, for example, and/or may comprise the Internet, with communication links between the controller device 110 and the third-party device 106, for example.

The third-party device 106, in some embodiments, may comprise any type or configuration a computerized processing device such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the controller device 110). The third-party device 106 may, for example, be owned and/or operated by a service provider such as a data and/or data service provider. In some embodiments, the third-party device 106 may comprise a data source and/or supply and/or provide data such as geospatial and/or weather data and/or other data to the controller device 110 and/or the user devices 102a-n. The third-party device 106 may, for example, comprise a geospatial weather data source and/or device such as a third-party weather data provider—e.g., the National Oceanic and Atmospheric Administration (NOAA) National Weather Service (NWS) and/or National Climactic Data Center (NCDC). In some embodiments, the third-party device 106 may comprise a plurality of devices and/or may be associated with a plurality of third-party entities.

In some embodiments, the controller device 110 may comprise an electronic and/or computerized controller device such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

According to some embodiments, the controller device 110 may store and/or execute specially programmed instructions to operate in accordance with embodiments described herein. The controller device 110 may, for example, execute one or more programs that facilitate the utilization of geospatial, weather, and/or claim data in the analysis, handling, processing, pricing, underwriting, and/or issuance of one or more insurance and/or underwriting products and/or claims with respect thereto. According to some embodiments, the controller device 110 may comprise a computerized processing device such as a PC, laptop computer, computer server, and/or other electronic device to manage and/or facilitate transactions and/or communications regarding the user devices 102a-n. A claim handler, underwriter, and/or other user (e.g., customer, client, or company) may, for example, utilize the controller device 110 to (i) assess and/or analyze one or more insurance claims (e.g., based on geospatially referenced weather data), (ii) assess the risk on one or more insurance products, (iii) price and/or underwrite one or more products such as insurance, indemnity, and/or surety products, (iv) determine and/or be provided with geospatial, weather, and/or claim data and/or other information, (v) assess a level, category, weight, score, and/or rank of geospatial, weather, and/or claim data for one or more policies, products, customers, and/or claims, and/or (vi) provide an interface via which a user may manage and/or facilitate claim handling processes (e.g., in accordance with embodiments described herein).

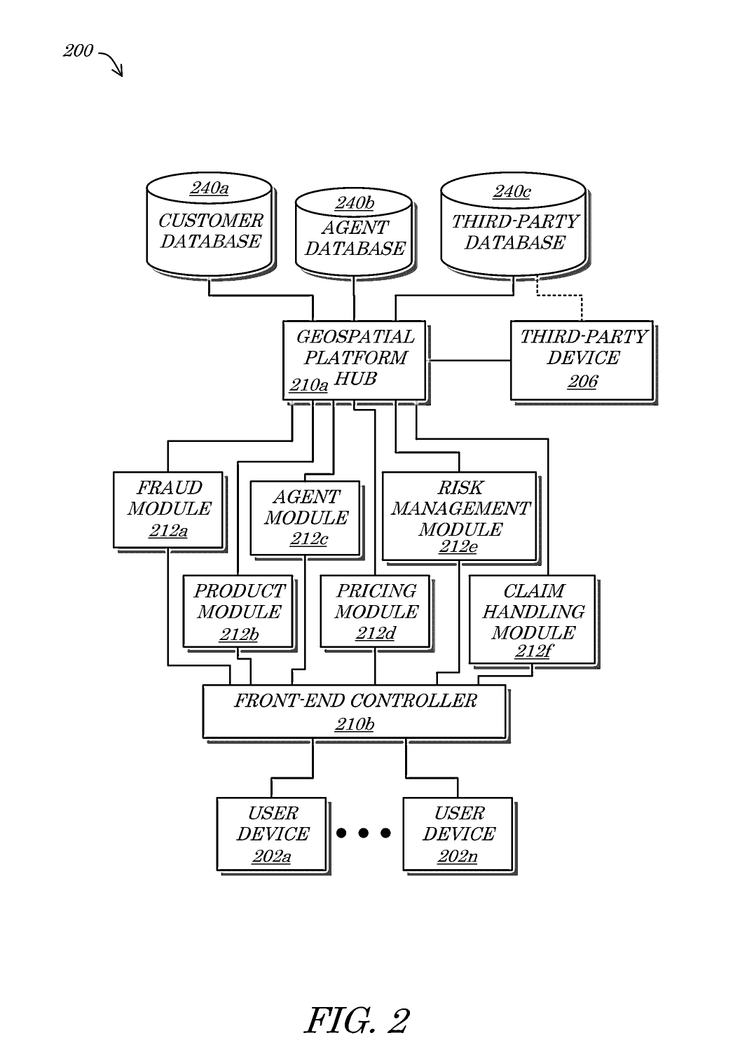

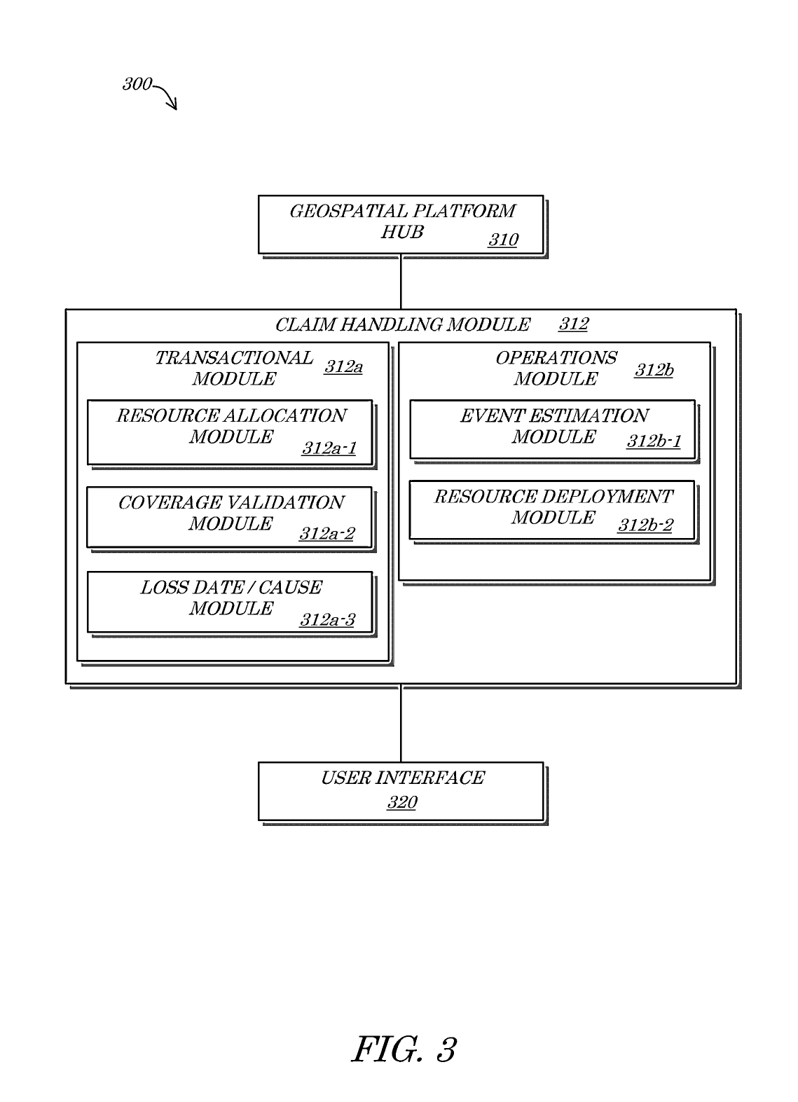

Turning now to FIG. 2, a block diagram of a system 200 according to some embodiments is shown. In some embodiments, the system 200 may comprise a plurality of user devices 202a-n, a third-party device 206, a geospatial platform hub 210a, a front-end controller 210b, one or more processors and/or processing devices such as a fraud module 212a, a product module 212b, an agent module 212c, a pricing module 212d, a risk management module 212e, and/or a claim handling module 212f, and/or one or more databases 240a-c (e.g., a customer database 240a, an agent database 240b, and/or a third-party database 240c). In some embodiments, the system 200 may be utilized to gather, aggregate, receive, analyze, process, and/or provide geospatial data, weather data (e.g., georeferenced weather data), claim loss data (e.g. Date of Loss (DOL), location of loss, and/or type of loss), claim handling data and/or determinations, and/or other data or metrics. The modules 212a-f may interface with one or more of the databases 240a-c (and/or the third-party device 206) via the geospatial platform hub 210a, for example, and/or may interface with one or more of the user devices 202a-n via the front-end controller 210b to utilize georeferenced weather data to analyze insurance claims, in accordance with embodiments described herein.

In some embodiments, the geospatial platform hub 210a may gather and/or receive geolocation, weather, customer, and/or other data from the databases 240a-c and/or from or via the third-party device 206. Customer data from the customer database 240a may comprise, for example, data descriptive of a location associated with a particular insurance policy, data descriptive of one or more terms and/or parameters of the policy, data descriptive of one or more claims associated with the insurance policy, and/or data descriptive of one or more characteristics of an object associated with the insurance policy (e.g., a home or office in the case of a property insurance policy or a vehicle in the case of an automobile insurance policy). According to some embodiments, agent data from the agent database 240b may comprise data descriptive of one or more logistical and/or workforce characteristics such as identifying, qualification/experience/expertise, and/or location information for an available (and/or particular) claim adjuster, insurance agent, CSR, and/or other user of the system 200. In some embodiments, data from the third-party database 240c and/or the third-party device 206 may comprise weather event and/or geolocational information.

Weather data may comprise, for example, NOAA NWS, NCDC, and/or National Severe Storms Laboratory (NSSL) data and/or other third-party (municipal or private) weather service data such as NEXt-Generation RADar (NEXRAD) data (e.g., S-band Doppler radar data in accordance with the IEEE Standard 521 (1984)), Terminal Doppler Weather Radar (TDWR) data, and/or weather metric, index, and/or algorithm data (e.g., Vertically Integrated Liquid (VIL) data, VIL density data, wind gust algorithm data, hail algorithm data, mesocyclone algorithm data, Tornado Vortex Signature (TVS) algorithm data, wind shear algorithm data, and/or Velocity Azimuth Display (VAD) Wind Profile (VWP) algorithm data. Weather data may comprise raw data (e.g., radar and/or satellite data, such as radar maximum and/or minimum readings), pre-filtered and/or processed data (e.g., “cleansed”), and/or analyzed and/or derived data (e.g., algorithm results or outcomes such as wind speed, wind direction, hail size, hail type, maximum hail probability, hail duration, estimated cloud layer elevations (e.g., echo top), precipitation locations, durations, and/or accumulations, precipitation types, storm tracks, etc.). In some embodiments, weather data may comprise data from one or more of a variety of weather and/or weather-related sensors such as satellite sensors (e.g., imagery or otherwise), storm surge and/or water level sensors (e.g., stream or river level or flow sensors), temperature sensors, etc.

Geolocation data may comprise, in some embodiments, data descriptive of one or more coordinates such as ‘x’, ‘y’, and/or ‘z’ coordinates, Global Positioning System (GPS) coordinates, Latitude and Longitude coordinates, easting and northing, etc. In some embodiments, the geolocation data may comprise location attribute and/or metadata and/or may be or include an indicator of uniqueness. Each specific point or location on earth, for example, may be assigned a particular identifier to uniquely address the point/location with respect to other points/locations. According to some embodiments, such as in the context of insurance processes, uniqueness may be defined with respect to a customer and/or potential customer, family, business, policy/product, risk (potential and/or actual), and/or claim. A postal code may not typically be suitable to establish uniqueness of a location, for example, because an insurance company may have multiple customers in the same postal code. A combination of the postal code and a street address however, may serve to distinguish a particular customer/policy from all other customers/policies for a particular insurance company. In some embodiments, geolocation information may comprise and/or define one or more “certified location” identifiers and/or associated data such as described in co-pending U.S. patent application Ser. No. 13/836,429 filed on Mar. 15, 2013 in the name of COLLINS et al. and titled “SYSTEMS AND METHODS FOR CERTIFIED LOCATION DATA COLLECTION, MANAGEMENT, AND UTILIZATION”, the certified location concepts and descriptions of which are hereby incorporated by reference herein.

According to some embodiments, the geospatial platform hub 210a may store, rank, sort, and/or otherwise process some or all received and/or retrieved data from the databases 240a-c. The geospatial platform hub 210a may, for example, store geolocation, weather, agent, and/or customer data in a relational manner. In such a manner, for example, one or more of the processing modules 212a-f may utilize the stored data and/or relationships defined there between to facilitate claims handling and/or other geolocational and/or weather event-based insurance processing as described herein.

In some embodiments, the processing modules 212a-f may access and/or interface with the geospatial platform hub 210a (and/or the databases 240a-b) to process geospatial, weather, agent, and/or insurance data. The fraud module 212a may, for example, utilize geospatial data and/or weather data (e.g., from the third-party database 240c) and customer data (e.g., from the customer database 240a) to process one or more algorithms and/or apply one or more rules or rule sets to determine a likelihood of an occurrence of fraud (e.g., based on an insurance claim submitted by a customer). In some embodiments, the product module 212b may, for example, utilize geospatial data (e.g., from the third-party database 240c), customer data (e.g., from the customer database 240b), and insurance agent data (e.g., from the agent database 240b) to tailor insurance and/or other underwriting product offerings to individual agents, customers, and/or groups thereof. The agent module 212c may, for example, utilize geospatial data and/or weather data (e.g., from the third-party database 240c) and insurance agent/employee data (e.g., from the agent database 240b) to allocate claim handling and/or other agent resources—e.g., to meet expected location-specific needs due to a weather event. The pricing module 212d may, for example, utilize geospatial data and/or weather data (e.g., from the third-party database 240c) and customer data (e.g., from the customer database 240a) to price product premiums, deductibles, surcharges, and/or discounts. The risk management module 212e may, for example, utilize geospatial data and/or weather data (e.g., from the third-party database 240c) and/or customer data (e.g., from the customer database 240a) to analyze, predict, and/or otherwise determine risk and/or risk metrics associated with a customer, location, object, product, and/or policy (or groups or classifications thereof).

According to some embodiments, the claim handling module 212f may utilize geospatial data and/or weather data (e.g., from the third-party database 240c) and customer data (e.g., from the customer database 240a) to facilitate, inform, define, and/or conduct insurance claim handling processes (e.g., as described herein). The claim handling module 212f may, for example, utilize insurance claim information (e.g., from the customer database 240a and/or received from a user device 202a-n), such as claim location and/or DOL, and georeferenced weather data (e.g., from the geospatial platform hub, the third-party device 206, and/or the third-party database 240c) to determine whether (and/or to what extent) a claim should be paid.

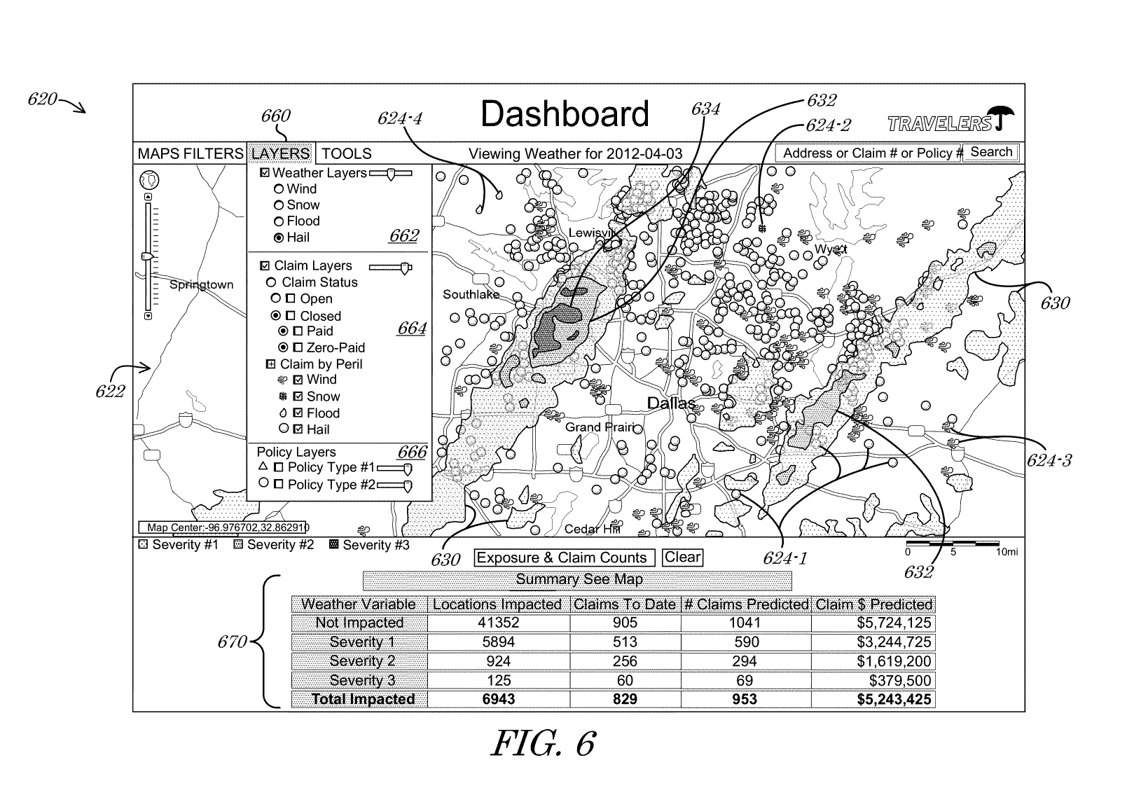

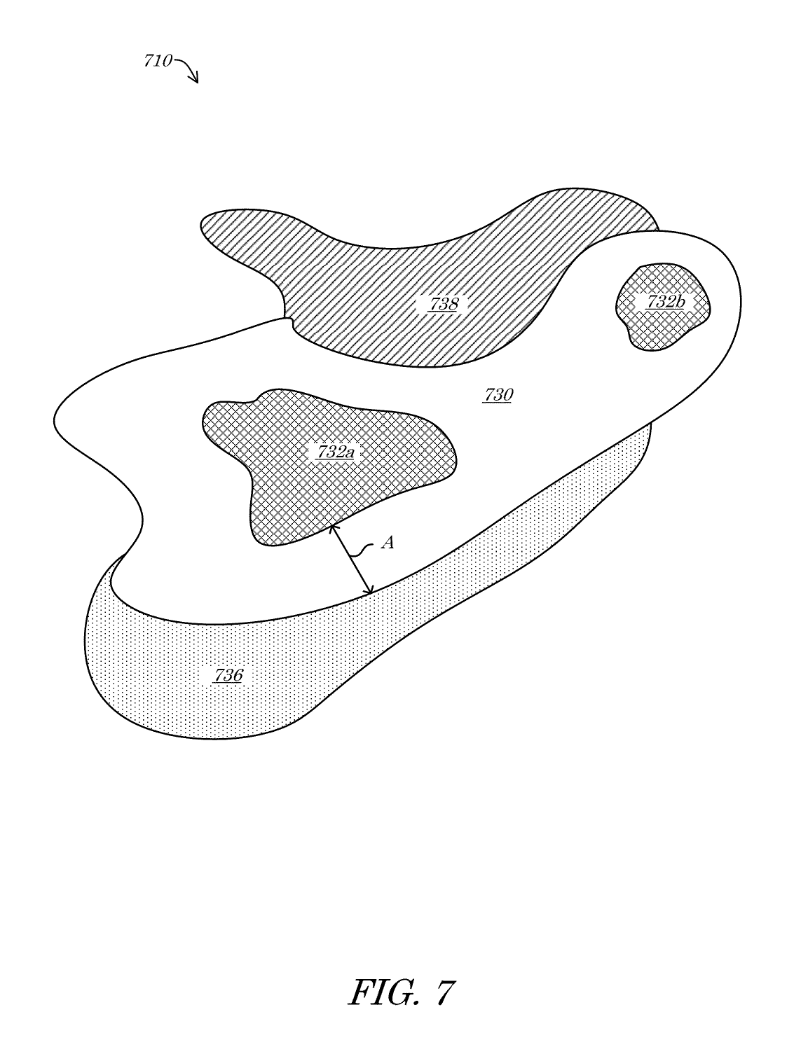

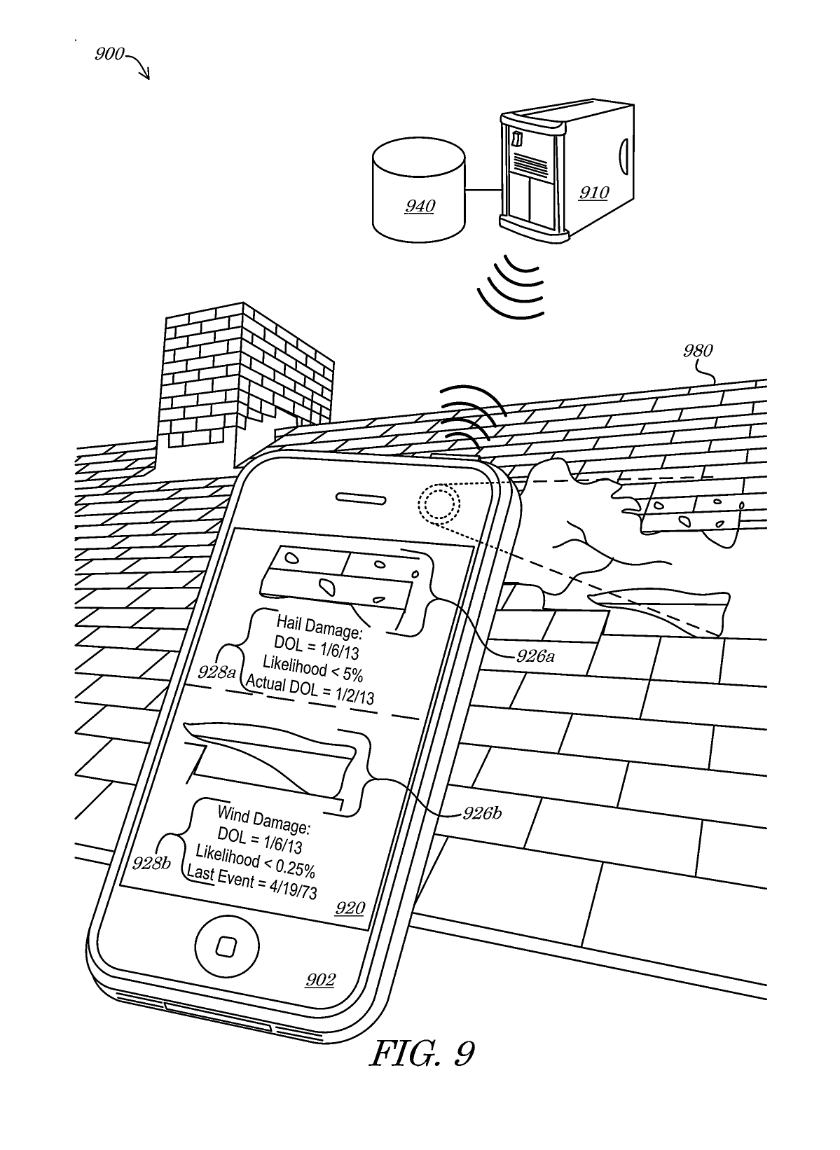

In some embodiments for example, a customer or claim handler/adjuster may utilize one or more of the user devices 202a-n to analyze claim data and/or facilitate claim handling. The user devices 202a-n may provide and/or transmit data to the front-end controller 210b (and/or the front-end controller 210b may receive from the user devices 202a-n), for example, which may function as an interface (and/or provide an interface such as the interfaces 320, 620, 920 of FIG. 3, FIG. 6, and/or FIG. 9 herein) between the user device 202a-n and one or more of the processing modules 212a-f. In some embodiments, claim data (such as claim location, DOL, and/or claim type data) may be provided by a first user device 202a to and/or via the front-end controller 210b. The front-end controller 210b may comprise, for example, a server-side (e.g., remote from the first user device 202a) processor and/or processing device such as a web server, for example, that provides and/or serves one or more web pages and/or other interface to the first user device 202a. According to some embodiments, the front-end controller 210b may comprise a client-side object and/or components such as a web browser plug-in and/or a mobile device application or other program that facilitates, prompts, and/or guides identification, entry, and/or provision of claim data from the first user device 202a to one or more appropriate (e.g., automatically selected and/or determined by the front-end controller 210b) and/or desired (e.g., user-selected; such as based on an indication received from the first user device 202a) processing modules 212a-f. In the exemplary case of the system 200 being utilized to facilitate and/or conduct a claim handling process, the claim handling module 212f may be interfaced with the first user device 202a via the front-end controller 210b. In such a manner, for example, the claim handling module 212f may provide claim handling data and/or determinations (such as whether a claim is deemed valid, and/or to what extent the claim will be paid by an insurance carrier) to the first user device 202a.

Fewer or more components 202a-n, 206, 210a-b, 212a-f, 240a-c and/or various configurations of the depicted components 202a-n, 206, 210a-b, 212a-f, 240a-c may be included in the system 200 without deviating from the scope of embodiments described herein. In some embodiments, the components 202a-n, 206, 210a-b, 212a-f, 240a-c may be similar in configuration and/or functionality to similarly named and/or numbered components as described herein. In some embodiments, the system 200 (and/or portion thereof) may comprise a claim handling program and/or platform programmed and/or otherwise configured to execute, conduct, and/or facilitate the method 400 of FIG. 4 and/or portions thereof described herein.

Referring now to FIG. 3, a block diagram of a system 300 according to some embodiments is shown. In some embodiments, the system 300 may comprise a geospatial platform hub 310 and/or a processor and/or processing device such as a claim handling module 312. In some embodiments, the claim handling module 312 may comprise one or more of a transactional module 312a and an operations module 312b. The transactional module 312a may comprise, for example, a resource allocation module 312a-1, a coverage validation module 312a-2, and/or a loss date/cause module 312a-3. According to some embodiments, the operations module 312b may comprise an event estimation module 312b-1 and/or a resource deployment module 312b-2. In some embodiments, the system 300 may comprise a user interface 320. In some embodiments, the system 300 may be utilized to gather, aggregate, receive, analyze, process, and/or provide geospatial data, weather data (e.g., georeferenced weather data), claim loss data (e.g., DOL, location of loss, and/or type of loss), claim handling data and/or determinations, and/or other data or metrics. The claim handling modules 312a-b may interface with the geospatial platform hub 310, for example, to provide georeferenced weather event-based insurance claim handling determinations via the user interface 320 (e.g., to one or more customers, agents, claim adjusters, etc.—none of which is explicitly shown in FIG. 3), in accordance with embodiments described herein.

In some embodiments, the resource allocation module 312a-1 (of the transactional module 312a) may comprise stored and/or programmed logic, definitions, rules, routines, and/or procedures configured to determine which available resources would be best suited to handle a particular incoming (e.g., via the user interface 320) claim handling task/request. The type and/or location of a claimed loss, for example, may be utilized with reference to the geospatial platform hub 310 (and information available there from) to select one or more particular claim handlers/adjusters, third-party service providers, and/or other resources appropriate for the claim. Claim handlers or service providers having expertise and/or experience with a particular type of claim or loss similar or identical to a type of claim or loss of a current request, for example, may be identified as the most appropriate resources to assign to the claim. In some embodiments, claim/loss location may be compared to locations of available claim handlers and/or service providers to determine which providers/handlers are situated closest to the current claim/loss. According to some embodiments, each available agent/handler/service provider may be ranked or scored based on geographic proximity to the claim/loss and technical expertise or experience (e.g., by the resource allocation module 312a-1). The scores and/or ranks may then be utilized, in accordance with some embodiments, to select one or more most appropriate (e.g., highest ranked and/or scored) resource(s) to assign to the claim/loss.

According to some embodiments, the coverage validation module 312a-2 (of the transactional module 312a) may comprise stored and/or programmed logic, definitions, rules, routines, and/or procedures configured to determine if, and to what extent, a particular claim/loss is covered by an insurance policy/product. The coverage validation module 312a-2 may, for example, compare received claim/loss data (e.g., received via the user interface 320), such as loss location and/or loss type, to applicable insurance policy information. It may be determined, for example, whether the location of the loss qualifies for coverage under a particular insurance policy and/or whether the type (or characteristics) of the loss qualifies for coverage under the policy. According to some embodiments, the coverage validation module 312a-2 may calculate, predict, and/or determine an available amount of coverage (e.g., an amount of possible payment, payment cap, etc.) for the claim/loss—e.g., based on policy and/or insurance company parameters. The user interface 320 may be utilized in conjunction with the coverage validation module 312a-2, for example, to provide a visual analysis tool (e.g., a Graphical User Interface (GUI) and/or map interface) via which the extent of claim/loss coverage may be analyzed (see, for example, the example interface 620 of FIG. 6 herein).

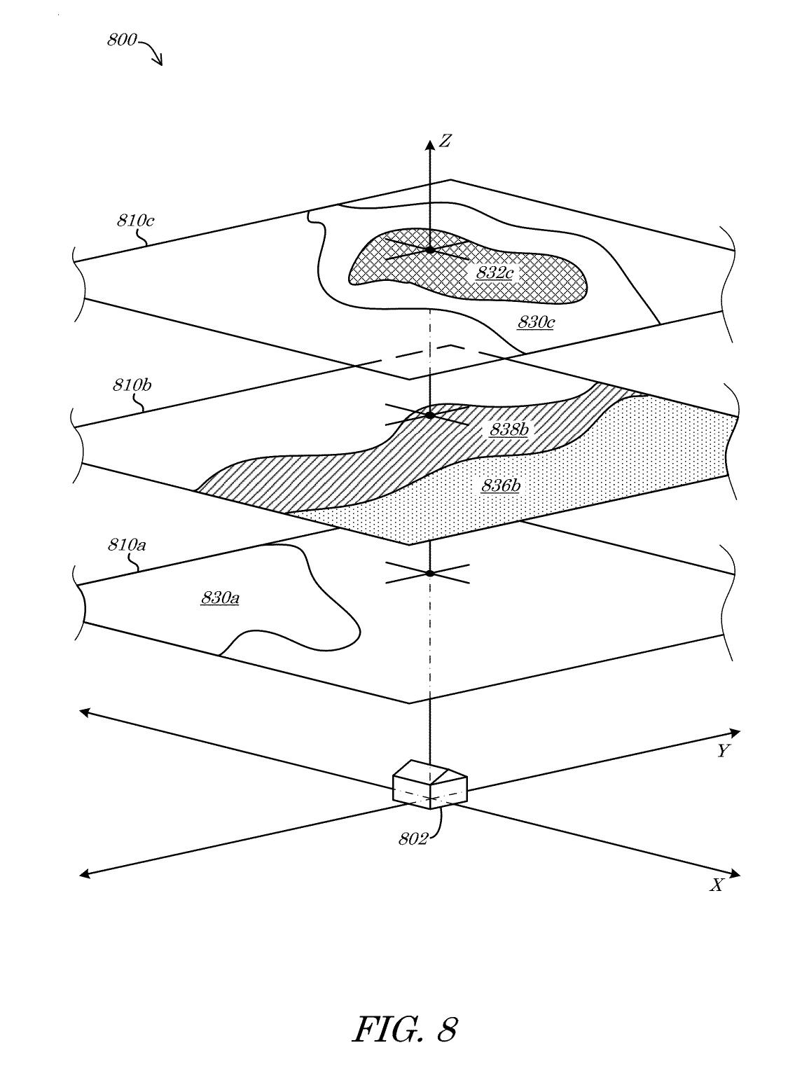

In some embodiments, the loss date/cause module 312a-3 (of the transactional module 312a) may comprise stored and/or programmed logic, definitions, rules, routines, and/or procedures configured to determine an appropriately categorized Cause Of Loss (COL) and an appropriate DOL for the claim/loss. The loss date/cause module 312a-3 may, for example, utilize claim/loss data received via the user interface 320 and stored georeferenced weather data from the geospatial platform hub 310 to determine whether the particular loss was likely caused by a weather event at the location. Geospatially-referenced weather data from the geospatial platform hub 310 may be utilized by the loss date/cause module 312a-3, for example, to determine a likelihood or probability that any particular weather event caused the loss at the location. In the case that the determined probability exceeds a predetermined threshold, it may be determined that a particular weather event is likely to have caused the loss and/or that the claim should be paid. Differing threshold levels may be set as desired. Certain likelihood/probability thresholds may be utilized to authorize full claim payment, for example, while other thresholds may be established to set partial claim payment caps, percentages, ranges, or amounts. The user interface 320 may be utilized in conjunction with the loss date/cause module 312a-3, for example, to provide a visual analysis tool (e.g., a GUI and/or map interface) via which the likely date of the claim/loss with respect to weather events may be analyzed (see, for example, the exemplary system 800 of FIG. 8 and the data layers 810a-c thereof).

According to some embodiments, the event estimation module 312b-1 (of the operations module 312b) may comprise stored and/or programmed logic, definitions, rules, routines, and/or procedures configured to apply a predictive model to one or more particular weather events (real—historic or current, or predicted/future). Claim and/or loss information from a plurality of insurance claims may be analyzed with respect to weather and/or location data, for example, to predict how many insurance claims are expected from a weather event (real or simulated), which customers are likely to submit claims, when claims are likely to be submitted/occur, and/or how much value of loss is expected to be claimed (e.g., carrier exposure). In some embodiments, the predictive model may be based on a plurality of variables such as (i) a claim history of insured customers within weather event-affected locations, (ii) deductible levels for such affected customers, (iii) coverage levels for the affected customers, and/or (iv) insured object characteristics associated with the affected customers (e.g., roof material types of insured structures, construction types, etc.). In some embodiments, corporate reserves may be set and/or altered based on the predictive model results. The user interface 320 may be utilized in conjunction with the event estimation module 312b-1, for example, to provide a visual analysis tool (e.g., a GUI and/or map interface) via which total weather event-based exposure may be analyzed (see, for example, the example interface 620 of FIG. 6 herein).

According to some embodiments, the resource deployment module 312b-2 (of the operations module 312b) may comprise stored and/or programmed logic, definitions, rules, routines, and/or procedures configured to identify, select, route, and/or deploy various insurance carrier resources in response to a weather event. The resource deployment module 312b-2 may be utilized, for example, to select appropriate numbers and/or types of claim handlers and/or third-party vendors to activate for deployment based on weather event parameters. The resource deployment module 312b-2 may also or alternatively be utilized to schedule, route, and/or direct such resources to particular locations associated with the weather event. Data from the event estimation module 312b-1 may be utilized by the resource deployment module 312b-2, for example, to automatically assign appropriate levels of resources to appropriate locations based on georeference weather data and historic claim data, as processed by the weather event-based predictive model. The user interface 320 may be utilized in conjunction with the resource deployment module 312b-2, for example, to provide a visual analysis tool (e.g., a GUI and/or map interface) via which available resources may be deployed (e.g., automatic selection, reservation, and/or booking of an appropriate number of airline seats to specific destinations and/or hotel rooms at automatically selected properties based on geolocational information related to the weather event), routed (e.g., automatic travel routing based on geospatial weather data), and/or assigned (e.g., based on actual and/or predicted claim levels at particular locations).

Fewer or more components 310, 312a-b, 320 and/or various configurations of the depicted components 310, 312a-b, 320 may be included in the system 300 without deviating from the scope of embodiments described herein. In some embodiments, the components 310, 312a-b, 320 may be similar in configuration and/or functionality to similarly named and/or numbered components as described herein. In some embodiments, the system 300 (and/or portion thereof) may comprise a claim handling program and/or platform programmed and/or otherwise configured to execute, conduct, and/or facilitate the method 400 of FIG. 4 and/or portions thereof described herein.

Turning now to FIG. 4, a flow diagram of a method 400 according to some embodiments is shown. In some embodiments, the method 400 may be implemented, facilitated, and/or performed by or otherwise associated with the system 100 of FIG. 1 herein (and/or portions thereof, such as the controller device 110). In some embodiments, the method 400 may be implemented via a Graphical User Interface (GUI) such as one or more of the interfaces 320, 620, 920 of FIG. 3, FIG. 6, and/or FIG. 9 herein.

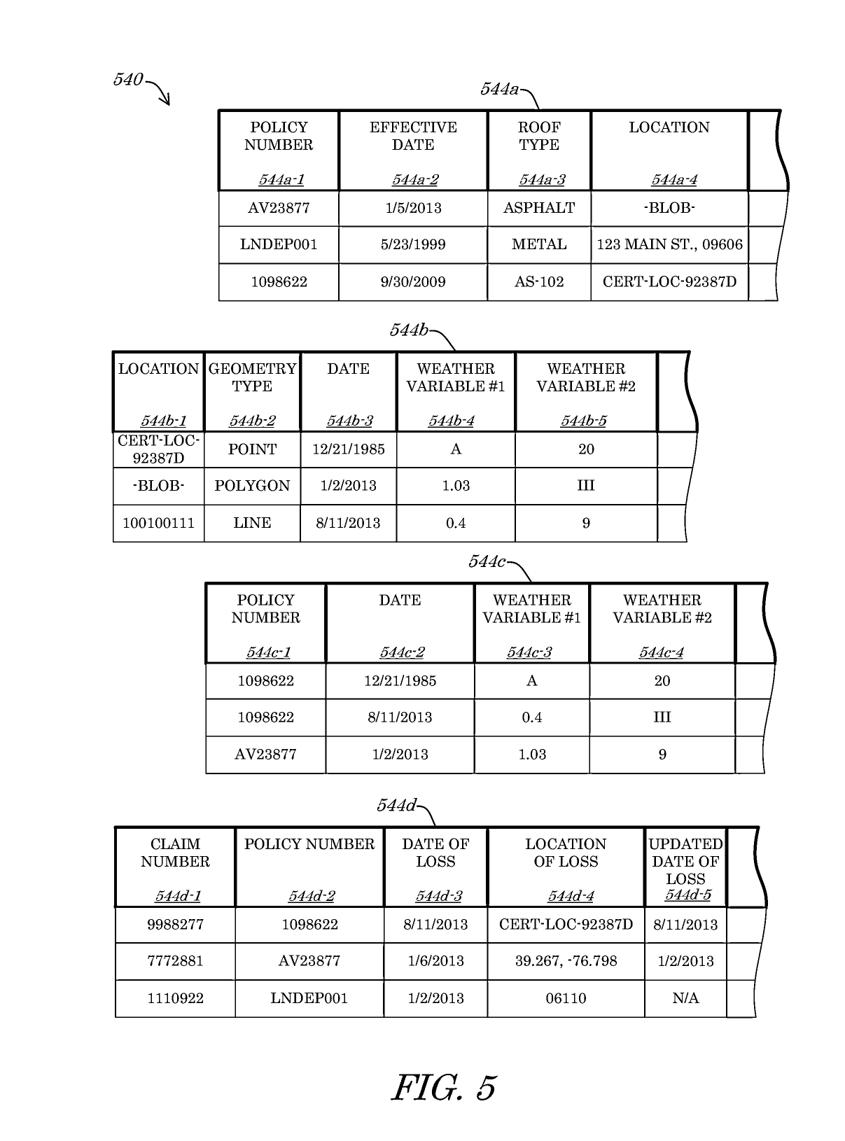

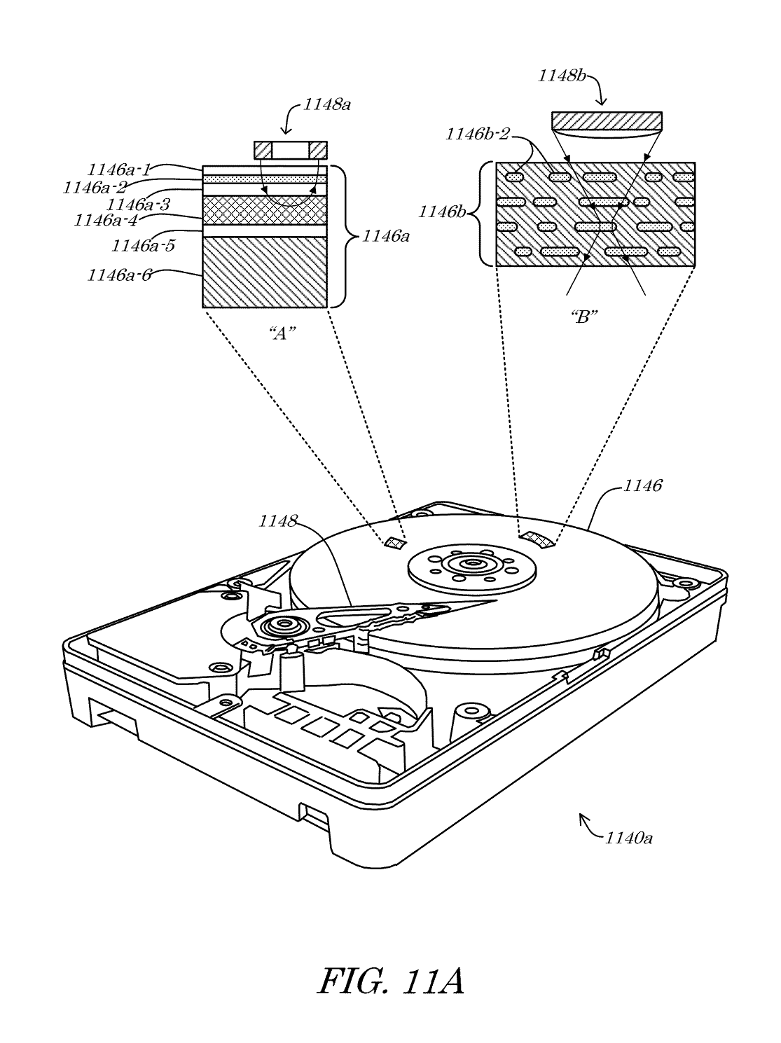

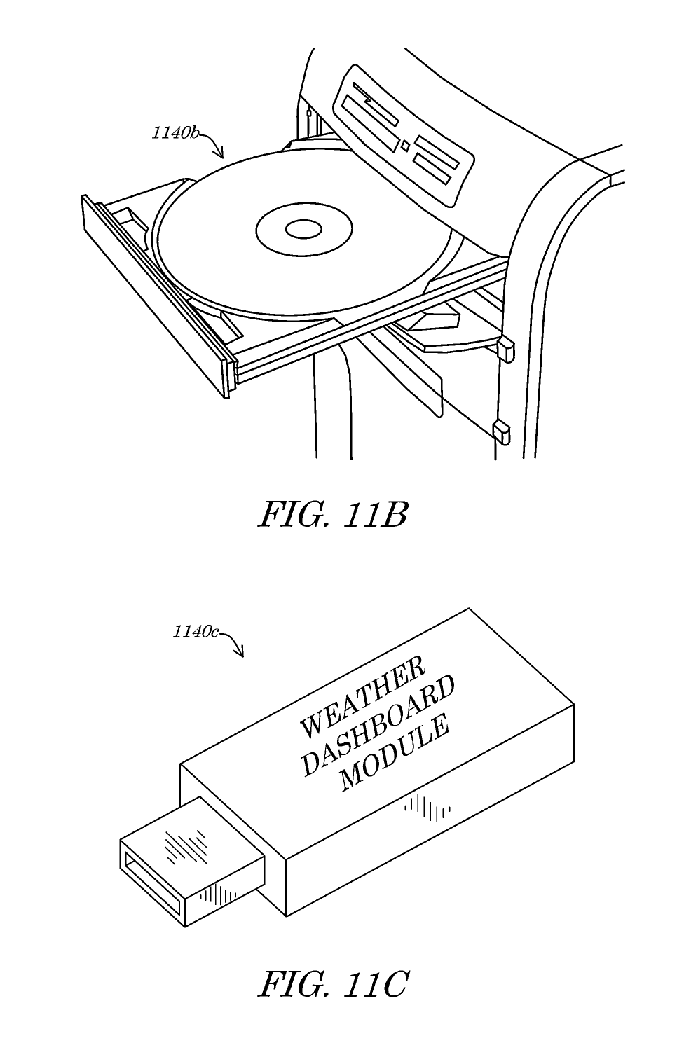

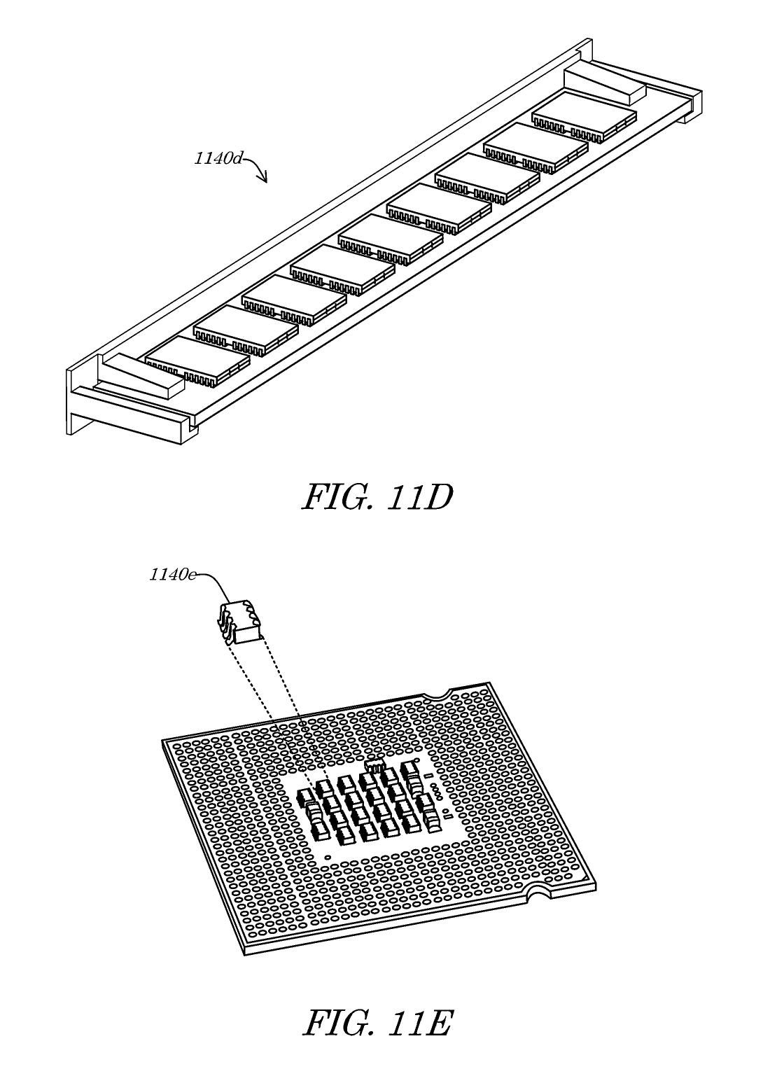

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 240a-c, 540, 940, 1140a-e of FIG. 2, FIG. 5, FIG. 9, FIG. 11A, FIG. 11B, FIG. 11C, FIG. 11D, and/or FIG. 11E herein) may store thereon instructions that when executed by a machine (such as a computerized processor) result in performance according to any one or more of the embodiments described herein.

According to some embodiments, the method 400 may comprise determining (e.g., by a processing device) (i) a locational coordinate of a weather-related loss associated with an insurance claim and (ii) a date of the loss (e.g., DOL), at 402. A user device of a customer or claim adjuster (or other field agent of an insurance company) may, for example, provide and/or transmit claim information to a centralized server (e.g., a processing device; which accordingly receives such transmitted data) such as an insurance company server—e.g., via a mobile device application and/or via a web page and/or web interface. The locational coordinate data may comprise, in some embodiments, an indication of a GPS coordinate, a cellular and/or other signal triangulation grid location, a street address, and/or any portions or combinations thereof. The DOL may be estimated based on empirical data available to the user device and provided to the processing device, may be based on a date of the receiving (or transmission), and/or may be explicitly defined (e.g., based on an indication from the user). According to some embodiments, the DOL may be estimated and/or set based on known weather event information not received from the user device—e.g., particularly in the case that a claim from the user device (and/or associated with the particular locational coordinate) was predicted or expected based on an occurrence of a known weather event that is predicted to have affected the locational coordinate.

In some embodiments, the method 400 may comprise determining (e.g., by the processing device), based on stored georeferenced weather data, a likelihood of weather on the date of loss at the locational coordinate having caused the loss, at 404. In the case that the DOL is automatically determined or assumed (at 402), such as based on a likelihood of being associated with a particular weather event at the locational coordinate, the likelihood may be predetermined or established and/or the determining of the likelihood may occur prior to receiving claim data (e.g., prior to 402). In some embodiments, irrespective of the source and/or timing of the locational coordinate data and/or the DOL data, the DOL and the locational coordinate may be utilized to lookup stored weather data for the same date and at the same location. In some embodiments, the stored weather data may comprise a rating, level, probability, and/or likelihood of damage or loss due to the weather event at the particular location (e.g., at the locational coordinate and/or at a set of locational coordinates including the particular locational coordinate). Stored and/or programmed logic, rules, and/or criteria (such as thresholds or data ranges) may then be utilized, for example, to determine whether it is likely that the weather event (assuming there was a weather event on the DOL) caused the claimed damage/loss at the locational coordinate. As a non-limiting example only, in the case that analyzed radar data and/or metrics indicate that the locational coordinate (e.g., a GPS coordinate falling with a particular polygon of coordinates associated with georeferenced weather data) experienced hail of a certain size, type, and/or duration on the DOL, it may be determined that there is a “high” probability (i.e., qualitative) or a ninety-percent (90%) chance (i.e., quantitative) that the weather event caused hail damage at the locational coordinate (and/or to roofs or other objects of certain types—e.g., standard grade asphalt shingle would have likely been damaged, while commercial grade architectural asphalt shingles would not have likely been damaged).

According to some embodiments, the method 400 may comprise determining (e.g., by the processing device), based on an application of stored claim handling rules to the determined likelihood of the loss having been caused by weather at the locational coordinate on the date of loss, whether (and/or to what extent) to pay the claim, at 406. A claim handling application (for use by claim handlers and/or customers) executed by a server and/or a mobile device may, for example apply one or more rules to the determined probability of causal relation between the weather on the DOL and the claimed loss (e.g., from 404) to determine, derive, calculate, and/or define a level of payment appropriate for the insurance claim. As described herein, different thresholds of probabilities/likelihoods may be established and utilized to define different claim handling outcomes. Exceeding a first probability threshold may result in a twenty-five percent (25%) payment of the full coverage amount, for example, while exceeding a second and/or higher probability threshold may result in a full payment to the extent of available coverage for the loss. According to some embodiments, the amount of determined payment may be based on effective deductibles for an associated insurance policy. The payment amount may comprise an amount of allowed coverage minus any applicable deductible, for example.

In some embodiments, the method 400 may comprise causing (e.g., by the processing device) an outputting of an indication of the probability of the loss being related to a weather event on the DOL and/or of the determination of an outcome of the claim (e.g., an extent to which the claim will be paid). The claim analysis and/or outcome data may, for example, be output via a display device, provided to one or more users via a webpage, and/or transmitted to one or more user devices. In some embodiments, the outputting may comprise causing an application on a user's mobile device to output a GUI (e.g., an interface 320, 620, 920 from FIG. 3, FIG. 6, and/or FIG. 9 herein) comprising a human-readable indication of the claim analysis and/or outcome data (and/or one or more values thereof—e.g., a dollar amount that will be paid, and/or an indication that such an amount has been transferred, wired, etc.).

According to some embodiments, the method 400 may comprise a determination that the DOL is incorrect and/or that no weather event was likely to have caused damage (or the specific type of damage) at the locational coordinate on the DOL. In such cases, the method 400 may comprise determining an updated or corrected DOL. Historic georeferenced weather data for the locational coordinate may be analyzed, for example, to determine if the claimed loss was likely to have been sustained on a different date (e.g., the DOL could be incorrect—for innocent or nefarious reasons). In some embodiments, the method 400 may comprise comparing the DOL and/or the updated/corrected DOL to policy information to determine if coverage for the type of loss at the locational coordinate was in force on the DOL/corrected DOL. In the case that coverage did not exist (e.g., the policy and/or particular type of coverage did not exist), the payment amount determined at 406 would be zero (0). In the case that coverage did exist, the method 400 could be implemented to update and/or correct the claim to provide an amount of payment determined to be appropriate based on insurance carrier rules and/or parameters.

Referring now to FIG. 5, a diagram of an example data storage structure 540 according to some embodiments is shown. In some embodiments, the data storage structure 540 may comprise a plurality of data tables such as an insurance policy data table 544a, a weather event data table 544b, a policy event data table 544c, and/or a claim data table 544d. The data tables 544a-d may, for example, be utilized (e.g., in accordance with the method 400 of FIG. 4 herein) to store, determine, and/or utilize geolocation, weather event, and insurance policy (e.g., customer) data (e.g., provided by a user device 102a-n, 202a-n, 902 of FIG. 1, FIG. 2, and/or FIG. 9 herein), such as to assess risk for (e.g., providing risk and/or loss control services), price, quote, adjust claims for, sell, renew, revise, and/or re-sell one or more risk management products (e.g., underwriting products). In some embodiments, the data tables 544a-d may be utilized to perform and/or provide various services such as adjusting, pricing, underwriting, servicing, marketing, and/or making recommendations (e.g., risk, marketing, and/or other recommendations).

The insurance policy data table 544a may comprise, in accordance with some embodiments, a policy number field 544a-1, an effective date field 544a-2, a roof type field 544a-3, and/or location field 544a-4. Any or all of the number and/or ID fields (e.g., the policy number field 544a-1) described herein may generally store any type of identifier that is or becomes desirable or practicable (e.g., a unique identifier, an alphanumeric identifier, and/or an encoded identifier). According to some embodiments, the insurance policy data table 544a may generally store data associated with customers and policies of an insurance company.

In some embodiments, the policy number field 544a-1 may store data indicative of a particular insurance policy or other risk management, investment, and/or underwriting product. According to some embodiments, the effective date field 544a-2 may store data indicative of one or more dates (e.g., start date, end date) that govern and/or define when the particular insurance policy (or other product) is effective (e.g., “in force”). In some embodiments, the roof type field 544a-3 may store data indicative of a type of roofing material installed on a structure that is the subject of the insurance policy (e.g., a residence or business). In some embodiments, the roof type field 544a-3 may store other or additional data relating to type of construction, age of roof, or other physical characteristics of an object associated with the insurance policy. In some embodiments, the location field 544a-4 may store data indicative of one or more locational coordinates descriptive of a physical location of the object/structure.

The weather event data table 544b may comprise, in accordance with some embodiments, a location field 544b-1, a geometry type field 544b-2, a date field 544b-3, a weather variable #1 field 544b-4, and/or a weather variable #2 field 544b-5. According to some embodiments, the weather event data table 544b may generally store data associated with weather event data, such as georeferenced weather data and/or other sensor-related data.

In some embodiments, the location field 544b-1 may store data indicative of one or more locational coordinates descriptive of a physical location affected by a particular weather event. In some embodiments, the location field 544b-1 may store data of the same type as the location field 544a-4 of the insurance policy data table 544a. The location field 544b-1 may, for example, be utilized as a database key relating the weather event data table 544b to the insurance policy data table 544a. In such a manner, for example, georeferenced weather events may be queried with respect to the locations of policies and/or customers of an insurance company. In some embodiments, the weather event data table 544b may comprise and/or be associated with a georelational data model (e.g., implemented via an object-based shapefile and/or via a relational Teradata model). The location field 544b-1 (like location field 544a-4 of insurance policy data table 544a) may store, for example, data descriptive of various georelational location shapes or objects, such as coordinate data, binary, hexadecimal, and/or other machine code, and/or one or more Binary (or Basic) Large OBject (BLOB or BLOb) data elements and/or one or more Character Large OBject (CLOB) data elements.

According to some embodiments, the geometry type field 544b-2 may store data indicative of a type of locational object such as a point, line, and/or polygon. A locational object may, for example, comprise and/or be defined by a set of locational coordinates or points—e.g., defining a line or polygon. In such a manner, for example, locational coordinates may be compared to the point, line, and/or polygon to determine any coincidence, overlap, and/or measure of proximity or georelation.

In some embodiments, the date field 544b-3 may store data indicative of one or more dates during which a particular weather event affected a particular location or locations. As described herein, for example, the data stored in the date field 544b-3 may be compared to the data stored in the effective date field 544a-2 of the insurance policy data table 544a to determine if a weather event (e.g., for a specific location associated with an insurance policy—e.g., the locational coordinate stored in the location field 544a-4 of the insurance policy data table 544a) is/was associated with an insurance policy during a period when the policy is/was in force. In some embodiments, the weather variable #1 field 544b-4 may store data indicative of a measure of a particular (e.g., a first) weather variable (e.g., snow load, snow duration, and/or hail size). In the case of hail size, for example, a size (e.g., diameter) of hail associated with a particular weather event may be stored. Radar data may be analyzed, for example, to determine an average, maximum, and/or other representation, analytical description, or measure of the size of the hail produced by the weather event (e.g., at the locational coordinate). In some embodiments, the weather variable #2 field 544b-5 may store data indicative of one or more measures, metrics, or indices descriptive of a second weather variable. In the case of a hail index or metric, for example, that data may be indicative of one or more measures, metrics, or indices descriptive of hail activity for the weather event—e.g., based on results from a Hail Detection Algorithm (HDA). The weather variable #2 field 544b-5 may store, for example, a known, measured, predicted, and/or estimated value for one or more hail index formulas or benchmarks, such as the “Craven Hail Index”, the “Pino-Moore Hail Index”, the “Foster-Bates Hail Index”, and/or a Sever Hail Index (SHI). According to some embodiments, any or all of the data stored in the weather variable #1 field 544b-4 and the weather variable #2 field 544b-5 may be utilized to predict, estimate, and/or otherwise determine a likelihood or probability of the associated weather event having caused damage (or damage of a specific type—such as hail damage (generally), roof damage, etc.) at the locational coordinate. While hail data is utilized for exemplary purposes, it should be understood that other weather metrics may also or alternatively be utilized to inform claim handling (and/or other) insurance processes, as is or becomes known or practicable.

The policy event data table 544c may comprise, in accordance with some embodiments, a policy number field 544c-1, a date field 544c-2, a weather variable #1 field 544c-3, and/or a weather variable #2 field 544c-4. According to some embodiments, the policy event data table 544c may generally store data descriptive of weather events that have occurred with respect to insurance customer and/or policies (and/or other products).

In some embodiments, the policy number field 544c-1 may store data of the same type as the policy number field 544a-1 of the insurance policy data table 544a. The policy number field 544c-1 may, for example, be utilized as a database key relating the policy event data table 544c to the insurance policy data table 544a. In such a manner, for example, georeferenced weather event data may be stored in association with insurance customer, account, and/or policy information. According to some embodiments, the date field 544c-2, the weather variable #1 field 544c-3, and the weather variable #2 field 544c-4 may store data similar to the data stored in the similarly named data fields 544b-3, 544b-4, 544b-5 of the weather event data table 544b.

The claim data table 544d may comprise, in accordance with some embodiments, a claim number field 544d-1, a policy number field 544d-2, a DOL field 544d-3, a location of loss field 544d-4, and/or an updated DOL field 544d-5. According to some embodiments, the claim data table 544d may generally store data associated with one or more insurance claims made with respect to a customer, account, policy, and/or product.

According to some embodiments, the claim number field 544d-1 may store an indicator of a particular claim that has been filed with respect to an insurance policy. In some embodiments, the policy number field 544d-2 may store data of the same type as the policy number field 544a-1 of the insurance policy data table 544a and/or the policy number field 544c-1 of the policy event data table 544c. The policy number field 544d-2 may, for example, be utilized as a database key relating the policy event data table 544c and/or the insurance policy data table 544a to the claim data table 544d. In such a manner, for example, georeferenced weather event data and/or insurance policy information related thereto may be stored in association with claim information. In some embodiments, the DOL field 544d-3 may store data descriptive of one or more dates and/or times associated with a particular insurance claim and/or loss. The DOL field 544d-3 may store, for example, data descriptive of a date on which an insurance customer or claimant believes a loss covered under their insurance policy occurred. In some embodiments, the location of loss field 544d-4 may store information descriptive of one or more locational coordinates associated with the claimed loss. According to some embodiments, the location of loss field 544d-4 may store information similar to the location field 544a-4 of the insurance policy data table 544a and/or the location field 544b-1 of the weather event data table 544b. The location of loss field 544d-4 may, for example, be utilized as a database key relating the insurance policy data table 544a and/or the weather event data table 544b to the claim data table 544d. In such a manner, for example, georeferenced weather event and/or insurance policy data may be stored in association with insurance claim data. In some embodiments, the updated DOL field 544d-5 may store updated, corrected, and/or alternate DOL data. In the case that the original or primary DOL data stored in the DOL field 544d-3 is determined not to be associated with a weather event that is likely to have caused the claimed loss, for example, a new, updated, and/or corrected loss date determined by cross-referencing historic weather event data with the loss location may be stored in the updated DOL field 544d-5.

In some embodiments, fewer or more data fields than are shown may be associated with the data tables 544a-d. Only a portion of one or more databases and/or other data stores is necessarily shown in any of FIG. 5, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

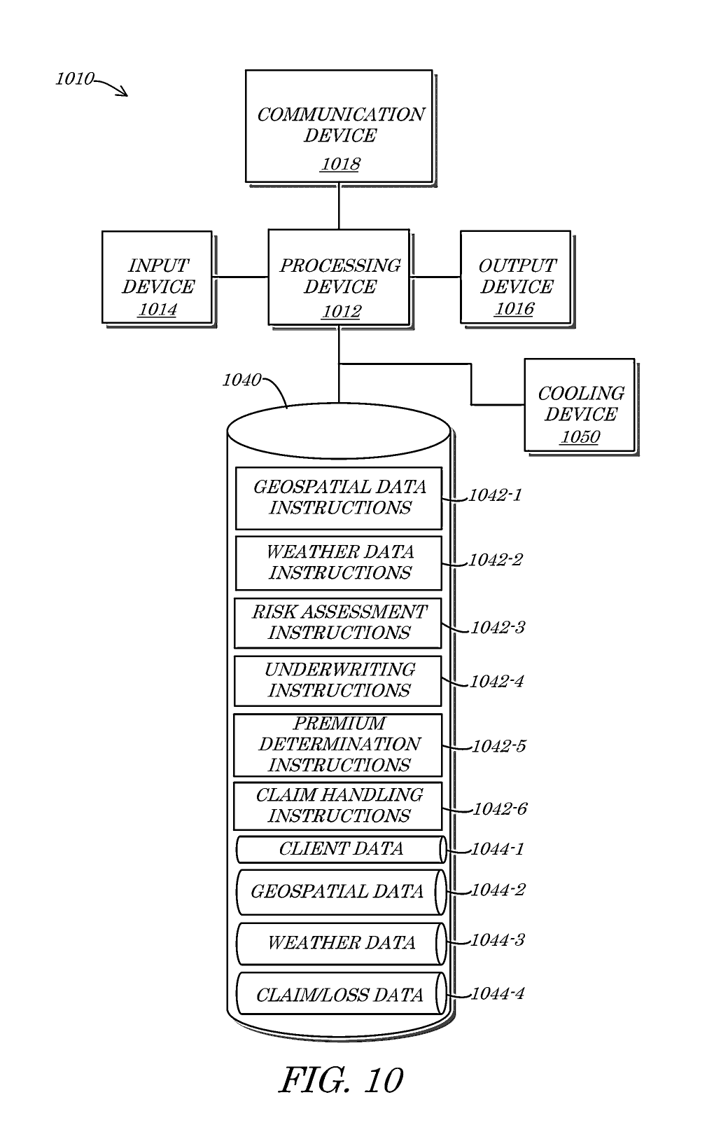

Turning now to FIG. 6, an example interface 620 according to some embodiments is shown. In some embodiments, the interface 620 may comprise a web page, web form, database entry form, Application Programming Interface (API), spreadsheet, table, and/or application or other GUI via which a claim handler/adjuster and/or other entity may enter, review, and/or analyze georeferenced weather event and/or claim data, and/or via which a user may utilize and/or apply georeferenced weather data to conduct claim investigations and/or facilitate product underwriting (and/or portions thereof such as risk assessments and/or preventative plan development and/or management). The interface 620 may, for example, comprise a front-end of a claim handling program (and/or portion thereof) and/or platform programmed and/or otherwise configured to execute, conduct, and/or facilitate any of the method 400 of FIG. 4 and/or portions thereof described herein. In some embodiments, the interface 620 may be output via a computerized device (e.g., a processor or processing device) such as one or more of the user devices 102a-n, 202a-n, 902 and/or the controller devices 110, 210a-b, 310, 910, 1010 of FIG. 1, FIG. 2, FIG. 3, FIG. 9, and/or FIG. 10 and/or the processors/processing devices 212a-f, 312a-b, 1012 of FIG. 2, FIG. 3, and/or FIG. 10 herein. In some embodiments, the example interface 620 may comprise interface outputs of (and/or otherwise associated with) a GUI utilized to research, analyze, resolve, and/or investigate an insurance and/or underwriting product claim and/or to price, quote, purchase/sell, re-sell, and/or otherwise configure an underwriting product, such as may be implemented and/or provided as described herein.

In some embodiments, the interface 620 may comprise a map portion 622. As depicted for non-limiting exemplary purposes in FIG. 6, the map portion 622 displays a map of the greater Dallas, Tex. area. In particular, the map portion 622 provides a graphical display depicting a relationship between weather event data and insurance policy locations and/or claims. The map portion 622 may comprise, for example, a plurality of claim indicators (or icons) 624 representing locations (e.g., positions of particular locational coordinates) associated with various insurance claims such as may be visualized by outputting (i) hail damage claim indicators 624-1, (ii) snow damage claim indicators 624-2, (iii) wind damage claim indicators 624-3, and/or (iv) flood damage claim indicators 624-4. In some embodiments, each of the claim indicators 624 and/or claim indicator types 624-1, 624-2, 624-3, 624-4 may be included on a separate data layer (not explicitly depicted in FIG. 6)—e.g., such that individual layers may be turned on or off (i.e., displayed or not displayed) for desired data visualization. In some embodiments, the depicted geolocation information for the displayed claim indicators 624 may be received from a customer, customer device, claim handler, claim handler device, and/or third-party data source—all as described herein.

According to some embodiments, the map portion 622 may comprise one or more weather event indicators, such as may be represented by an outputting of (i) primary storm zones 630, (ii) secondary storm zones 632, and/or (iii) tertiary storm zones 634. The primary storm zones 630 may, for example, comprise one or more areas, shapes, boundaries, and/or polygons (e.g., stored and/or defined as part of a georelational data model, such as by utilization of BLOB data elements) representing a first or primary type and/or magnitude of weather event. The primary storm zones 630 depicted in FIG. 6, for example, may indicate a certain likelihood (e.g., that a certain threshold of probability or confidence has been reached or established) that weather having a first severity level occurred and/or caused damage (e.g., hail in the range of one to two inches (1 to 2 inches; 2.54 to 5.08 cm)) in the indicated areas. Similarly, in some embodiments, the secondary storm zones 632 may indicate that weather having a second severity level occurred and/or caused damage (e.g., hail in the range of two to three inches (2 to 3 inches; 5.08 to 7.62 cm)) in the indicated areas and/or the tertiary storm zones 634 may indicate that weather having a third severity level occurred and/or caused damage (e.g., hail in the range of greater than three inches (>3 inches; >7.62 cm)) in the indicated areas. As described herein, such storm zones 630, 632, 634 may be based on and/or defined by georeferenced weather event data such as geospatial radar data received from one or more third-party sources. According to some embodiments, each of the storm zones 630, 632, 634 may be included on a separate data layer (not explicitly depicted in FIG. 6)—e.g., such that individual layers may be turned on or off (i.e., displayed or not displayed) for desired data visualization.

In some embodiments, the interface 620 may comprise a layers tool 660 that allows a user of the interface to set viewing preferences in accordance with desired data visualization goals. The layers tool 660 may comprise, for example, a plurality of weather layer options 662, a plurality of claim layer options 664, and/or a plurality of policy layer options 666. The weather layer options 662 may, for example, allow a user to define which available weather event data layers are output via the interface 620. As depicted in the example of FIG. 6, the weather layer options 662 have been set to cause the interface 620 to display “Hail” weather event data—e.g., as depicted by the storm zones 630, 632, 634. The claim layer options 664 may, for example, allow a user to define which available insurance claim data layers are output via the interface 620. As depicted in the example of FIG. 6, the claim layer options 664 have been set to cause the interface 620 to display (i) all “Closed” claims (e.g., paid and unpaid) and (ii) all claims, regardless of associated peril (e.g., COL)—e.g., as depicted by the claim indicators 624 and/or claim indicator types 624-1, 624-2, 624-3, 624-4. The policy layer options 666 may, for example, allow a user to define which available insurance policy data layers are output via the interface 620. As depicted in the example of FIG. 6, the policy layer options 666 have not been set to limit displayed data based on insurance policy type(s)—e.g., property, automobile, renters, condo, high-value home, and/or other policy types.

While the data visualization of the map portion 622 in and of itself may provide numerous advantages in claim handling, policy analysis, and/or predictive modeling (e.g., exposure and/or resource planning), the interface 620 may provide further benefits by incorporating data query and/or analysis functionality. In some embodiments for example, the interface 620 may comprise an exposure query table 670. The exposure query table 670 may, for example, provide data analysis, comparison, and/or calculation results relating weather event data to claim data (e.g., based on geospatial unity, proximity, and/or overlap). All locational coordinates and/or all policies, customers, accounts, groups, products, and/or policies displayed in the map portion 620 may, for example, be compared to one or more of the storm zones 630, 632, 634 to determine (i) if a particular location was likely impacted by a particular weather event type (e.g., hail, as shown for non-limiting exemplary purposes), (ii) to what extent the particular location was likely impacted by the weather event (e.g., type, duration, and/or size of hail (as shown for non-limiting exemplary purposes)), and/or (iii) of the impacted policies/customers/etc., how many claims have been filed, paid, not paid, etc. According to some embodiments, user input may define (e.g., the interface 620 may receive an indication of) a particular area or subset of the map portion 622 that is desired for analysis via the exposure query table 670. In such a manner, for example, a user may select certain portions of interest on the map portion 622 to provide targeted analysis focus. In some embodiments, individual policies (and/or specific groups of policies—e.g., for Personal Insurance (PI) and/or Business Insurance (BI) customers), customers, etc., may be selected for analysis. In such a manner, for example, a claim adjuster (and/or customer) may select a particular location, policy, claim, account, etc., and readily determine if, and to what extent, the selected location, policy, claim, account, etc. was likely exposed to weather events (e.g., on a certain date and/or for one or more ranges of dates). In some embodiments, the exposure query table 670 may also or alternatively comprise predictive data, such as a number of predicted claims (e.g., within a particular georeferenced polygon, at a particular location (e.g., a PI policy location) and/or across a plurality of specific locations (e.g., a plurality of related BI policy locations)) and/or an amount of predicted/estimated claim or loss value (e.g., potential insurance company exposure).

While various components of the interface 620 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Referring now to FIG. 7, a block diagram of a data layer 710 according to some embodiments is shown. The data layer 710 may, for example, represent a geographic area overlaid with a chart, graph, and/or other graphical depiction or representation of weather event-based probabilities, likelihoods, metrics, and/or indices (in some embodiments, for example, the storm zones 630, 632, 634 of the interface 620 of FIG. 6 may comprise a single data layer (or related set of data layers), e.g., for a specific weather event, type of weather severity, date, and/or date range). The data layer 710 may comprise, for example, a primary weather event zone 730, one or more secondary weather event zones 732a-b, a weather event fringe zone 736, and/or a weather event outlier zone 738. According to some embodiments, the data layer 710 may comprise and/or define a buffer distance “A” relating the location and/or bounds of the secondary weather event zones 732a-b with respect to the location and/or bounds of the primary weather event zone 730.

In some embodiments, the data layer 710 may represent weather event activity (e.g., activity of a first severity and/or level) over a particular geographic area (not depicted in FIG. 7) on a particular date (or date range). According to some embodiments, the primary weather event zone 730 may comprise and/or bound a set of locational coordinates that have been determined to have been exposed (or will likely be exposed, in the case of predictive modeling) to a particular type and/or magnitude of weather event (e.g., represented and/or defined by BLOB and/or other georelational data elements stored as part of a georelational data model such as may be represented by the example data storage structure 540 of FIG. 5 herein). The primary weather event zone 730 may represent, for example, a first magnitude of storm activity and/or a first type of storm activity (e.g., rain and/or rain of a certain intensity). In some embodiments, the secondary weather event zones 732a-b may comprise and/or bound a set of locational coordinates (e.g., a subset of those comprising and/or bounded by the primary weather event zone 730) that have been determined to have been exposed (or will likely be exposed, in the case of predictive modeling) to a particular type and/or magnitude of weather event. The secondary weather event zones 732a-b may represent, for example, a second magnitude (e.g., stronger than the first magnitude) of storm activity and/or a second type of storm activity (e.g., hail and/or hail of a certain size). According to some embodiments, the secondary weather event zones 732a-b may be based on and/or defined by georeferenced weather data such as radar data (e.g., such as the primary weather event zone 730 may be).

In some embodiments, the secondary weather event zones 732a-b may also or alternatively be defined by and/or based on the primary weather event zone 730. The buffer distance “A” may be set and/or defined, for example, to define the boundaries of one or more of the secondary weather event zones 732a-b in terms of an offset distance from the boundaries of the primary weather event zone 730. In some embodiments, the secondary weather event zones 732a-b and/or the buffer distance “A” may be defined based on confidence and/or probability levels. It may be determined, for example, that while the boundaries of the primary weather event zone 730 represent a particular probability threshold and/or confidence level of an occurrence of a storm of a particular intensity (e.g., a storm likely to have caused damage), that a certain geographic setback or offset may indicate a higher level of probability threshold and/or confidence level—e.g., with respect to specific probabilities or confidence levels such as seventy-five percent (75%) and ninety percent (90%) respectively or with respect to one or more generalized, approximate, and/or unspecified levels. In such a manner, for example, an area of increased confidence and/or probability of storm damage may be defined as one or more of the secondary weather event zones 732a-b. In any case, the secondary weather event zones 732a-b may be associated with different claim handling, estimation, and/or resource management rules or processes than other areas (e.g., different than the primary weather event zone 730). It may be determined, for example, that any claims falling within the secondary weather event zones 732a-b may automatically be paid (e.g., within coverage limits and taking into account appropriate deductibles) and/or that claim handlers, field agents, and/or other resources may automatically be deployed—e.g., based on a confidence level that a certain amount of such resources will be needed as a result of the weather event. In contrast, and in accordance with some embodiments, claims falling within the primary weather event zone 730 may not be automatically paid, but may require investigation and/or may automatically be authorized for payment up to a certain amount (e.g., fifty percent (50%) of coverage).

According to some embodiments, the weather event fringe zone 736 may comprise and/or bound a set of locational coordinates (e.g., a subset of those comprising and/or bounded by the primary weather event zone 730 and/or an at least partially different or non-overlapping subset) that have been determined to have been exposed (or will likely be exposed, in the case of predictive modeling) to a particular type and/or magnitude of weather event. The weather event fringe zone 736 may represent, for example, a third magnitude (e.g., weaker than the first and/or second magnitudes) of storm activity and/or a third type of storm activity (e.g., wind, and/or wind of a certain type, speed, and/or direction). According to some embodiments, the weather event fringe zone 736 may be based on and/or defined by georeferenced weather data such as radar data (e.g., such as the primary weather event zone 730 and/or the secondary weather event zones 732a-b may be). In some embodiments, the weather event fringe zone 736 may be defined based on data that leads to a determination that claims falling within the weather event fringe zone 736 require investigation and/or are expected to be more sporadic. According to some embodiments, the weather event fringe zone 736 may be defined based on altitude and/or wind or travel speed data associated with the weather event. It may be determined, for example, that due to storm speed and/or direction of travel and/or hail or rain altitude, speed, direction, etc., that although the storm did not pass over the locations in the weather event fringe zone 736, that there is a probability that precipitation from the storm did fall within the weather event fringe zone 736.

In some embodiments, the weather event outlier zone 738 may comprise and/or bound a set of locational coordinates that have been determined not to have been exposed (or will not likely be exposed, in the case of predictive modeling) to a particular type and/or magnitude of weather event. The weather event outlier zone 738 may represent, for example, an area where storm activity and/or magnitude is believed to be minimal, and/or accordingly, where a likelihood of damage is minimal (e.g., below a predetermined threshold). According to some embodiments, the weather event outlier zone 738 may be based on and/or defined by georeferenced weather data such as radar data (e.g., such as the primary weather event zone 730, the secondary weather event zones 732a-b, and/or the weather event fringe zone 736 may be). In some embodiments, the weather event outlier zone 738 may be defined based on data that leads to a determination that claims falling within the weather event outlier zone 738, e.g., with respect to a particular weather event type and/or damage type, are suspect, invalid, and/or properly referenced with respect to a different date. In some embodiments, claims falling with the weather event outlier zone 738 may be automatically rejected or not paid. In some embodiments, claims falling within the weather event outlier zone 738 may be deemed to be likely to indicative of insurance fraud.

Fewer or more components 730, 732a-b, 736, 738 and/or various configurations of the depicted components 730, 732a-b, 736, 738 may be included in the data layer 710 without deviating from the scope of embodiments described herein. In some embodiments, the components 730, 732a-b, 736, 738 may be similar in configuration and/or functionality to similarly named and/or numbered components as described herein. In some embodiments, the data layer 710 (and/or portion thereof) may be utilized by a claim handling program and/or platform programmed and/or otherwise configured to execute, conduct, and/or facilitate the method 400 of FIG. 4 and/or portions thereof described herein.

Turning now to FIG. 8, a perspective diagram of a system 800 according to some embodiments is shown. The system 800 may, for example, represent a specific geographic location 802 overlaid (and/or otherwise associated with) with a set and/or hierarchy of data layers 810a-c—e.g., charts, graphs, and/or other graphical depictions or representation of weather event-based probabilities, likelihoods, metrics, and/or indices. The system 800 may comprise, for example, a multi-dimensional depiction of the specific geographic location 802 (e.g., depicted for exemplary purposes as a residence or structure) disposed at a particular point identified by coordinates or locations along an “X”, “Y”, and “Z” axis—where the “X” and “Y” axes represent geospatial locations on a surface and the “Z” axis represents a layer element such as severity, type, and/or time (depicted as progressing from older to newer going from top to bottom, for non-limiting exemplary purposes only). In some embodiments, the data layers 810a-c may comprise representations (and/or data) of weather event data for the specific geographic location 802.

A first data layer 810a may, for example, comprise a first primary weather event zone 830a. The first data layer 810a and/or the first primary weather event zone 830a may, for example, be representative of georeferenced weather data of a particular type, severity, and/or from a particular date, time, and/or date and/or time range (e.g., a first type, severity, and/or date and/or time). As depicted for non-limiting exemplary purposes in FIG. 8, the first data layer 810a and/or the first primary weather event zone 830a may represent weather data from a first date such as the most recent available date, the most recent weather event date, and/or a specified DOL (e.g., an initial DOL provided by a customer and/or claim adjuster). As depicted, it may be assumed and/or determined from viewing the overlay (and/or analyzing the underlying data thereof) of the first data layer 810a with respect to the specific geographic location 802 that no weather event on the first date was likely to have caused damage at the specific geographic location 802 (e.g., as there is no overlap between the first primary weather event zone 830a and the specific geographic location 802).

A second data layer 810b may comprise, in accordance with some embodiments, a weather event fringe zone 836b and/or a weather event outlier zone 838b. The second data layer 810b, the weather event fringe zone 836b, and/or the weather event outlier zone 838b may, for example, be representative of georeferenced weather data of a particular type, severity, and/or from a particular date, time, and/or date and/or time range (e.g., a second type, severity, and/or date and/or time). As depicted for non-limiting exemplary purposes in FIG. 8, the second data layer 810b, the weather event fringe zone 836b, and/or the weather event outlier zone 838b may represent weather data from a second date such as a date previous to the most recent available date (e.g., the first date), a date previous to the most recent weather event date, and/or a date previous to a specified DOL (e.g., a date previous to an initial DOL provided by a customer and/or claim adjuster). As depicted, it may be assumed and/or determined from viewing the overlay (and/or analyzing the underlying data thereof) of the second data layer 810b, the weather event fringe zone 836b, and/or the weather event outlier zone 838b with respect to the specific geographic location 802 that only the weather event outlier zone 838b overlaps with the specific geographic location 802 on the second date. This may indicate, for example, that on the second date, there is either no likelihood that a weather event caused damage at the specific geographic location 802 and/or that any claim of damage for the second date may be likely to be indicative of fraud.

A third data layer 810c may comprise, in some embodiments, a second primary weather event zone 830c and/or a secondary weather event zone 832c. The third data layer 810c, the second primary weather event zone 830c, and/or the secondary weather event zone 832c may, for example, be representative of georeferenced weather data of a particular type, severity, and/or from a particular date, time, and/or date and/or time range (e.g., a third type, severity, and/or date and/or time). As depicted for non-limiting exemplary purposes in FIG. 8, the third data layer 810c, the second primary weather event zone 830c, and/or the secondary weather event zone 832c may represent weather data from a third date such as a date previous to the second date. As depicted, it may be assumed and/or determined from viewing the overlay (and/or analyzing the underlying data thereof) of the third data layer 810c, the second primary weather event zone 830c, and/or the secondary weather event zone 832c with respect to the specific geographic location 802 that it is highly likely (e.g., likely to a degree or level that exceeds a confidence threshold) that a weather event on the third date caused damage at the specific geographic location 802 (e.g., as the secondary weather event zone 832c overlaps with the specific geographic location 802).

According to some embodiments, the temporal data layers 810a-c (and/or the data utilized to generate the data layers 810a-c) may be utilized to determine when a loss is likely to have occurred. In some embodiments, such as in the case that the first date associated with the first data layer 810a comprises a DOL for an insurance claim, the previous dates (i.e., the second date and/or the third date) may be viewed and/or analyzed to determine when (other than the DOL, on which it is not likely the damage occurred; in the example of FIG. 8) the claimed loss is likely to have occurred (e.g., the third date, in the depicted example). In some embodiments, such an updated, corrected, and/or new DOL (e.g., the third date) may be compared to insurance policy parameters, such as effective dates, to determine if the claimed loss was covered at the time of occurrence.

Fewer or more components 802, 810a-c, 830a, 830c, 832c, 836b, 838b and/or various configurations of the depicted components 802, 810a-c, 830a, 830c, 832c, 836b, 838b may be included in the system 800 without deviating from the scope of embodiments described herein. In some embodiments, the components 802, 810a-c, 830a, 830c, 832c, 836b, 838b may be similar in configuration and/or functionality to similarly named and/or numbered components as described herein. In some embodiments, the system 800 (and/or portion thereof) may be utilized by a claim handling program and/or platform programmed and/or otherwise configured to execute, conduct, and/or facilitate the method 400 of FIG. 4 and/or portions thereof described herein.

Referring now to FIG. 9, a perspective diagram of a system 900 according to some embodiments is shown. In some embodiments, the system 900 may comprise a user device 902 (e.g., a mobile electronic device and/or a wireless electronic device), a server 910 (e.g., configured to wirelessly communicate and/or otherwise communicatively coupled to the user device 902), and/or a user interface 920 (e.g., output and/or displayed by or via the user device 902). In some embodiments, the user interface 920 may comprise one or more damage images 926a-b and/or claim handling data 928a-b. According to some embodiments, the system 900 may comprise a database 940 (e.g., in communication with the server 910) and/or an insured object 980 (depicted as a roof of a structure for non-limiting exemplary purposes). In some embodiments, the system 900 may be utilized to permit an insurance customer to perform remote self-reporting and/or analysis of an insurance claim with respect to the insured object 980. In some embodiments, the system 900 may be utilized to permit an insurance claim handler and/or other agent to perform remote reporting and/or analysis of an insurance claim with respect to the insured object 980 (and/or on behalf of the customer/insured).

According to some embodiments, the user device 902 may be utilized to sense and/or capture or record data associated with an insurance claim. The user device 902 may, as depicted in FIG. 9 for example, be utilized to take a picture of the insured object 980 and/or a portion thereof (e.g., the portion depicted as being damaged in FIG. 9). Other sensors may also or alternatively be utilized as part of and/or in conjunction with the user device 902 as is or becomes known or practicable. The user device 902 may comprise, for example, an automated device such as an Unmanned Aerial Vehicle (UAV), e.g., as described in U.S. Patent Application Publication No. 2009/0265193 titled “METHODS AND SYSTEMS FOR AUTOMATED PROPERTY INSURANCE INSPECTION” and filed on Apr. 17, 2009, the automated sensor and inspection concepts of which are hereby incorporated by reference herein. User input via the user interface 920 may also or alternatively be entered into (e.g., received by) the user device 902 (e.g., such as in the case that a user enters DOL data). In some embodiments, the data sensed, captured, and/or received by the user device 902 may be transmitted (and/or otherwise provided) to the server 910 (directly and/or via one or more other devices such as cell towers, repeaters, and/or other network devices not shown in FIG. 9).

In some embodiments, the server 910 may analyze and/or process the data received from the user device 902 such as by comparing the received data to data stored in the database 940. In accordance with embodiments described herein, for example, the user device 902 may provide locational coordinate information and DOL information to the server 910. The server 910 may then, for example, utilize the DOL and location information to query georeferenced weather event data stored in the database 940. In such a manner, for example, a likelihood or probability of the claimed loss (e.g., damage to the insured object 980) having occurred on the DOL as a result of a weather event may be determined. In some embodiments, the server 910 may send identified, looked-up, queried, calculated, and/or determined information to the user device 902 (e.g., in response to the receiving of claim data from the user device 902). The server 910 may, for example, provide some or all of the claim handling data 928a-b to the user device 902 (which may in turn, display and/or output the claim handling data 928a-b; as depicted).

According to some embodiments, the claim handling data 928a-b may comprise one or more data elements configured to facilitate the claim handling process. The claim handling data 928a-b may, for example, comprise the depicted COL data (e.g., “hail damage, “wind damage”), the DOL, a likelihood of the COL being correct for the DOL, and/or other date information (such as a revised or corrected DOL and/or information descriptive of previous weather events—e.g., not associated with the original DOL).

In some embodiments, the user device 902 and/or the server 910 may analyze image data received and/or acquired by the user device 902 to determine characteristics of the loss and/or claim. Data descriptive of the damaged roof of the insured object 980, for example, may be parsed, analyzed, and/or processed to determine (i) a type of loss (e.g., roof damage), (ii) a COL (e.g., hail damage, wind damage), and/or (iii) a magnitude of loss (e.g., a repair estimate). An application executed on the user device 902, for example, may analyze image data of the insured object 980 and output the damage images 926a-b. In some embodiments, the user device 902 and/or the server may determine that the insured object sustained different types of losses and/or may output the damage images 926a-b to indicate such varying COL data. A first damage image 926a may be parsed from an original image, for example, as being determined to be likely to be indicative of hail damage. A second damage image 926b may also or alternatively be parsed from the original image as being determined to be likely to be indicative of wind damage. In some embodiments, data indicative of the determined COL data may be sent to the server 910.

A first portion of the claim handling data 928a may accordingly be descriptive of claim handling with respect to a first COL (e.g., hail damage) while a second portion of the claim data 928b may be descriptive of claim handling with respect to a second COL (e.g., wind damage). Each COL type may be associated with different claim handling results based on an analysis of related georeferenced weather data. The first portion of the claim handling data 928a may indicate, as depicted for example, that hail damage on the DOL is not likely to have occurred at the location of the insured object 980. In some embodiments, the first portion of the claim handling data 928a may indicate that a determination has been made (e.g., by the user device 902 and/or the server 910) that the DOL is incorrect. While no hail damage was likely to have occurred on Jan. 6^{th}, 2013, for example, it may be determined that hail damage was likely just four (4) days before, on Jan. 2, 2013. In such a case, it may be determined that the original DOL was merely incorrect (e.g., due to poor recollection) or a potential fraud event (e.g., in the case that an associated insurance policy went into effect on Jan. 5^{th}, 2013—it may be presumed that the claim was back-dated in an attempt to receive payment for an uncovered loss). The second portion of the claim handling data 928b may indicate, as depicted for example, that wind damage on the DOL was not likely and that the most recent weather event that is likely to have caused wind damage occurred almost forty (40) years prior—e.g., an indication that the claim of wind damage should not be paid.

Fewer or more components 902, 910, 812a, 920, 926a-b, 928a-b, 940, 980 and/or various configurations of the depicted components 902, 910, 812a, 920, 926a-b, 928a-b, 940, 980 may be included in the system 900 without deviating from the scope of embodiments described herein. In some embodiments, the components 902, 910, 812a, 920, 926a-b, 928a-b, 940, 980 may be similar in configuration and/or functionality to similarly named and/or numbered components as described herein. In some embodiments, the system 900 (and/or portion thereof) may be utilized by a claim handling program and/or platform programmed and/or otherwise configured to execute, conduct, and/or facilitate the method 400 of FIG. 4 and/or portions thereof described herein.

Turning now to FIG. 10, a block diagram of an apparatus 1010 according to some embodiments is shown. In some embodiments, the apparatus 1010 may be similar in configuration and/or functionality to any of the controller devices 110, 210a-b, 310, 910, the user devices 102a-n, 202a-n, 902, and/or the third-party device 106, FIG. 1, FIG. 2, FIG. 3, and/or FIG. 9 herein. The apparatus 1010 may, for example, execute, process, facilitate, and/or otherwise be associated with the method 400 of FIG. 4, and/or portions thereof described herein. In some embodiments, the apparatus 1010 may comprise a processing device 1012, an input device 1014, an output device 1016, a communication device 1018, a memory device 1040, and/or a cooling device 1050. According to some embodiments, any or all of the components 1012, 1014, 1016, 1018, 1040, 1050 of the apparatus 1010 may be similar in configuration and/or functionality to any similarly named and/or numbered components described herein. Fewer or more components 1012, 1014, 1016, 1018, 1040, 1050 and/or various configurations of the components 1012, 1014, 1016, 1018, 1040, 1050 may be included in the apparatus 1010 without deviating from the scope of embodiments described herein.

According to some embodiments, the processor 1012 may be or include any type, quantity, and/or configuration of processor that is or becomes known. The processor 1012 may comprise, for example, an Intel® IXP 2800 network processor or an Intel® XEON™ Processor coupled with an Intel® E7501 chipset. In some embodiments, the processor 1012 may comprise multiple interconnected processors, microprocessors, and/or micro-engines. According to some embodiments, the processor 1012 (and/or the apparatus 1010 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1010 comprises a server such as a blade server, necessary power may be supplied via a standard AC outlet, power strip, surge protector, and/or Uninterruptible Power Supply (UPS) device. According to some embodiments, the processor 1012 may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc.

In some embodiments, the input device 1014 and/or the output device 1016 are communicatively coupled to the processor 1012 (e.g., via wired and/or wireless connections and/or pathways) and they may generally comprise any types or configurations of input and output components and/or devices that are or become known, respectively. The input device 1014 may comprise, for example, a keyboard that allows an operator of the apparatus 1010 to interface with the apparatus 1010 (e.g., by a consumer, such as to provide insurance claim data, and/or by an claim handler and/or insurance agent, such as to evaluate insurance claims—e.g., based on geospatially referenced weather data as described herein). In some embodiments, the input device 1014 may comprise a sensor configured to provide information such as geospatial, weather, and/or claim data to the apparatus 1010 and/or the processor 1012. The output device 1016 may, according to some embodiments, comprise a display screen and/or other practicable output component and/or device. The output device 1016 may, for example, provide insurance claims handling tools to an insurance policy holder (e.g., via a website) and/or to a claim handler attempting to investigate an insurance claim (e.g., via a computer workstation and/or mobile device). According to some embodiments, the input device 1014 and/or the output device 1016 may comprise and/or be embodied in a single device such as a touch-screen monitor.

In some embodiments, the communication device 1018 may comprise any type or configuration of communication device that is or becomes known or practicable. The communication device 1018 may, for example, comprise a Network Interface Card (NIC), a telephonic device, a cellular network device, a router, a hub, a modem, and/or a communications port or cable. In some embodiments, the communication device 1018 may be coupled to provide data to a remote mobile device, such as in the case that the apparatus 1010 is utilized to analyze insurance claims (e.g., based at least in part on geospatially referenced weather data). The communication device 1018 may, for example, comprise a cellular telephone network transmission device that sends signals indicative of historic weather data for a specific location to a handheld, mobile, and/or telephone device (e.g., of a claim adjuster). According to some embodiments, the communication device 1018 may also or alternatively be coupled to the processor 1012. In some embodiments, the communication device 1018 may comprise an IR, RF, Bluetooth™, NFC, and/or Wi-Fi® network device coupled to facilitate communications between the processor 1012 and another device (such as a client device and/or a third-party device, not shown in FIG. 10).

The memory device 1040 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1040 may, according to some embodiments, store one or more of geospatial data instructions 1042-1, weather data instructions 1042-2, risk assessment instructions 1042-3, underwriting instructions 1042-4, premium determination instructions 1042-5, claim handling instructions 1042-6, client data 1044-1, geospatial data 1044-2, weather data 1044-3, and/or claim/loss data 1044-4. In some embodiments, the geospatial data instructions 1042-1, weather data instructions 1042-2, risk assessment instructions 1042-3, underwriting instructions 1042-4, premium determination instructions 1042-5, claim handling instructions 1042-6 may be utilized by the processor 1012 to provide output information via the output device 1016 and/or the communication device 1018.

According to some embodiments, the geospatial data instructions 1042-1 may be operable to cause the processor 1012 to process the client data 1044-1, geospatial data 1044-2, weather data 1044-3, and/or claim/loss data 1044-4 in accordance with embodiments as described herein. Client data 1044-1, geospatial data 1044-2, weather data 1044-3, and/or claim/loss data 1044-4 received via the input device 1014 and/or the communication device 1018 may, for example, be analyzed, sorted, filtered, decoded, decompressed, ranked, scored, plotted, and/or otherwise processed by the processor 1012 in accordance with the geospatial data instructions 1042-1. In some embodiments, client data 1044-1, geospatial data 1044-2, weather data 1044-3, and/or claim/loss data 1044-4 may be fed by the processor 1012 through one or more mathematical and/or statistical formulas and/or models in accordance with the geospatial data instructions 1042-1 to define and/or determine one or more specific and/or unique locations (e.g., a locational coordinate) utilized to inform and/or affect insurance claim handling and/or other underwriting product determinations and/or sales as described herein.

According to some embodiments, the weather data instructions 1042-2 may be operable to cause the processor 1012 to process the client data 1044-1, geospatial data 1044-2, weather data 1044-3, and/or claim/loss data 1044-4 in accordance with embodiments as described herein. Client data 1044-1, geospatial data 1044-2, weather data 1044-3, and/or claim/loss data 1044-4 received via the input device 1014 and/or the communication device 1018 may, for example, be analyzed, sorted, filtered, decoded, decompressed, ranked, scored, plotted, and/or otherwise processed by the processor 1012 in accordance with the weather data instructions 1042-2. In some embodiments, client data 1044-1, geospatial data 1044-2, weather data 1044-3, and/or claim/loss data 1044-4 may be fed by the processor 1012 through one or more mathematical and/or statistical formulas and/or models in accordance with the weather data instructions 1042-2 to define and/or determine georeferenced weather data (e.g., radar data) utilized to inform and/or affect insurance claim handling and/or other underwriting product determinations and/or sales as described herein.

According to some embodiments, the risk assessment instructions 1042-3 may be operable to cause the processor 1012 to process the client data 1044-1, geospatial data 1044-2, weather data 1044-3, and/or claim/loss data 1044-4 in accordance with embodiments as described herein. Client data 1044-1, geospatial data 1044-2, weather data 1044-3, and/or claim/loss data 1044-4 received via the input device 1014 and/or the communication device 1018 may, for example, be analyzed, sorted, filtered, decoded, decompressed, ranked, scored, plotted, and/or otherwise processed by the processor 1012 in accordance with the risk assessment instructions 1042-3. In some embodiments, client data 1044-1, geospatial data 1044-2, weather data 1044-3, and/or claim/loss data 1044-4 may be fed by the processor 1012 through one or more mathematical and/or statistical formulas and/or models in accordance with the risk assessment instructions 1042-3 to analyze and/or determine risk based on georeferenced weather data and/or claim data, as described herein

According to some embodiments, the underwriting instructions 1042-4 may be operable to cause the processor 1012 to process the client data 1044-1, geospatial data 1044-2, weather data 1044-3, and/or claim/loss data 1044-4 in accordance with embodiments as described herein. Client data 1044-1, geospatial data 1044-2, weather data 1044-3, and/or claim/loss data 1044-4 received via the input device 1014 and/or the communication device 1018 may, for example, be analyzed, sorted, filtered, decoded, decompressed, ranked, scored, plotted, and/or otherwise processed by the processor 1012 in accordance with the underwriting instructions 1042-4. In some embodiments, client data 1044-1, geospatial data 1044-2, weather data 1044-3, and/or claim/loss data 1044-4 may be fed by the processor 1012 through one or more mathematical and/or statistical formulas and/or models in accordance with the underwriting instructions 1042-4 to define and/or determine insurance claim handling outcomes and/or other underwriting product determinations and/or sales as described herein

According to some embodiments, the premium determination instructions 1042-5 may be operable to cause the processor 1012 to process the client data 1044-1, geospatial data 1044-2, weather data 1044-3, and/or claim/loss data 1044-4 in accordance with embodiments as described herein. Client data 1044-1, geospatial data 1044-2, weather data 1044-3, and/or claim/loss data 1044-4 received via the input device 1014 and/or the communication device 1018 may, for example, be analyzed, sorted, filtered, decoded, decompressed, ranked, scored, plotted, and/or otherwise processed by the processor 1012 in accordance with the premium determination instructions 1042-5. In some embodiments, client data 1044-1, geospatial data 1044-2, weather data 1044-3, and/or claim/loss data 1044-4 may be fed by the processor 1012 through one or more mathematical and/or statistical formulas and/or models in accordance with the premium determination instructions 1042-5 to define and/or determine insurance and/or underwriting product premiums (e.g., based on weather-event-based classifications and/or codings) as described herein

According to some embodiments, the claim handling instructions 1042-6 may be operable to cause the processor 1012 to process the client data 1044-1, geospatial data 1044-2, weather data 1044-3, and/or claim/loss data 1044-4 in accordance with embodiments as described herein. Client data 1044-1, geospatial data 1044-2, weather data 1044-3, and/or claim/loss data 1044-4 received via the input device 1014 and/or the communication device 1018 may, for example, be analyzed, sorted, filtered, decoded, decompressed, ranked, scored, plotted, and/or otherwise processed by the processor 1012 in accordance with the claim handling instructions 1042-6. In some embodiments, client data 1044-1, geospatial data 1044-2, weather data 1044-3, and/or claim/loss data 1044-4 may be fed by the processor 1012 through one or more mathematical and/or statistical formulas and/or models in accordance with the claim handling instructions 1042-6 to define and/or determine insurance claim handling outcomes (e.g., based on loss location and/or georeferenced weather data) as described herein.

In some embodiments, the apparatus 1010 may function as a computer terminal and/or server of an insurance and/or underwriting company, for example, that is utilized to process insurance claims and/or applications. In some embodiments, the apparatus 1010 may comprise a web server and/or other portal (e.g., an Interactive Voice Response Unit (IVRU)) that provides georeferenced weather event-based claim and/or underwriting product determinations and/or products to users.

In some embodiments, the apparatus 1010 may comprise the cooling device 1050. According to some embodiments, the cooling device 1050 may be coupled (physically, thermally, and/or electrically) to the processor 1012 and/or to the memory device 1040. The cooling device 1050 may, for example, comprise a fan, heat sink, heat pipe, radiator, cold plate, and/or other cooling component or device or combinations thereof, configured to remove heat from portions or components of the apparatus 1010.

Any or all of the exemplary instructions and data types described herein and other practicable types of data may be stored in any number, type, and/or configuration of memory devices that is or becomes known. The memory device 1040 may, for example, comprise one or more data tables or files, databases, table spaces, registers, and/or other storage structures. In some embodiments, multiple databases and/or storage structures (and/or multiple memory devices 1040) may be utilized to store information associated with the apparatus 1010. According to some embodiments, the memory device 1040 may be incorporated into and/or otherwise coupled to the apparatus 1010 (e.g., as shown) or may simply be accessible to the apparatus 1010 (e.g., externally located and/or situated).

Referring to FIG. 11A, FIG. 11B, FIG. 11C, FIG. 11D, and FIG. 11E, perspective diagrams of exemplary data storage devices 1140a-e according to some embodiments are shown. The data storage devices 1140a-e may, for example, be utilized to store instructions and/or data such as the geospatial data instructions 1042-1, weather data instructions 1042-2, risk assessment instructions 1042-3, underwriting instructions 1042-4, premium determination instructions 1042-5, claim handling instructions 1042-6, client data 1044-1, geospatial data 1044-2, weather data 1044-3, and/or claim/loss data 1044-4, each of which is described in reference to FIG. 10 herein. In some embodiments, instructions stored on the data storage devices 1140a-e may, when executed by a processor, cause the implementation of and/or facilitate the method 400 of FIG. 4 and/or portions thereof, described herein.

According to some embodiments, the first data storage device 1140a may comprise one or more various types of internal and/or external hard drives. The first data storage device 1140a may, for example, comprise a data storage medium 1146 that is read, interrogated, and/or otherwise communicatively coupled to and/or via a disk reading device 1148. In some embodiments, the first data storage device 1140a and/or the data storage medium 1146 may be configured to store information utilizing one or more magnetic, inductive, and/or optical means (e.g., magnetic, inductive, and/or optical-encoding). The data storage medium 1146, depicted as a first data storage medium 1146a for example (e.g., breakout cross-section “A”), may comprise one or more of a polymer layer 1146a-1, a magnetic data storage layer 1146a-2, a non-magnetic layer 1146a-3, a magnetic base layer 1146a-4, a contact layer 1146a-5, and/or a substrate layer 1146a-6. According to some embodiments, a magnetic read head 1146a may be coupled and/or disposed to read data from the magnetic data storage layer 1146a-2.

In some embodiments, the data storage medium 1146, depicted as a second data storage medium 1146b for example (e.g., breakout cross-section “B”), may comprise a plurality of data points 1146b-2 disposed with the second data storage medium 1146b. The data points 1146b-2 may, in some embodiments, be read and/or otherwise interfaced with via a laser-enabled read head 1148b disposed and/or coupled to direct a laser beam (and/or other optical signal) through the second data storage medium 1146b.

In some embodiments, the second data storage device 1140b may comprise a CD, CD-ROM, DVD, Blu-Ray™ Disc, and/or other type of optically-encoded disk and/or other storage medium that is or becomes know or practicable. In some embodiments, the third data storage device 1140c may comprise a USB keyfob, dongle, and/or other type of flash memory data storage device that is or becomes know or practicable. In some embodiments, the fourth data storage device 1140d may comprise RAM of any type, quantity, and/or configuration that is or becomes practicable and/or desirable. In some embodiments, the fourth data storage device 1140d may comprise an off-chip cache such as a Level 2 (L2) cache memory device. According to some embodiments, the fifth data storage device 1140e may comprise an on-chip memory device such as a Level 1 (L1) cache memory device.

The data storage devices 1140a-e may generally store program instructions, code, and/or modules that, when executed by a processing device cause a particular machine to function in accordance with one or more embodiments described herein. The data storage devices 1140a-e depicted in FIG. 11A, FIG. 11B, FIG. 11C, FIG. 11D, and FIG. 11E are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a processor may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, specifically exclude software-only objects, modules, and/or components.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

In some embodiments, a method may comprise determining (e.g., by a processing device) (i) a locational coordinate of a weather-related loss associated with an insurance claim and (ii) a date of the loss, determining (e.g., by the processing device), based on stored georeferenced weather data, a likelihood of weather on the date of loss at the locational coordinate having caused the loss, and determining (e.g., by the processing device), based on an application of stored claim handling rules to the determined likelihood of the loss having been caused by weather at the locational coordinate on the date of loss, whether to pay the claim. According to some embodiments, the method may further comprise causing, in the case that it is determined that the claim should be paid, a payment of the claim. According to some embodiments, the determining of the locational coordinate of the weather-related loss associated with the insurance claim may comprise receiving (e.g., by the processing device), from a remote mobile device, data descriptive of the locational coordinate. According to some embodiments, the data descriptive of the locational coordinate may comprise GPS data identifying a location of the remote mobile device. According to some embodiments, the method may further comprise receiving (e.g., by the processing device), from a remote mobile device, data descriptive of the loss. According to some embodiments, the data descriptive of the loss may comprise an image of damage associated with the loss. According to some embodiments, the method may further comprise determining (e.g., by the processing device), based on the data descriptive of the loss received from the remote mobile device, a type of the loss. According to some embodiments, the type may comprise one or more of: (i) hail damage, (ii) wind damage, (iii) water damage, and (iv) lightning strike damage. According to some embodiments, the determining of the likelihood of the weather on the date of loss at the locational coordinate having caused the loss may comprise determining, based on the stored georeferenced weather data and the determined type of the loss, a likelihood that a type of weather associated with the type of the loss occurred at the locational coordinate on the date of the loss. According to some embodiments, the determining of the date of the weather-related loss associated with the insurance claim may comprise receiving an indication of the date of loss from a customer associated with the insurance claim. According to some embodiments, the determining of the likelihood of the weather on the date of loss at the locational coordinate having caused the loss may comprise determining that no weather event that occurred on the date of loss at the locational coordinate of the loss exceeds a predetermined magnitude threshold, identifying a different date in the past where a weather event exceeding the predetermined magnitude did occur at the locational coordinate, and determining whether an insurance policy associated with the insurance claim was in effect on the different date. According to some embodiments, the method may further comprise substituting, in the case that it is determined that the insurance policy was in force on the different date, the likelihood of weather on the date of loss at the locational coordinate having caused the loss with a likelihood that the identified weather event caused the loss on the different date. According to some embodiments, the locational coordinate may comprise a GPS coordinate. According to some embodiments, the locational coordinate may comprise a geospatial identifier that is unique to a specific insurance customer. According to some embodiments, the method may further comprise causing (e.g., by the processing device) an outputting of an indication of the determination of whether or not the claim will be paid.

In some embodiments, a method may comprise providing (e.g., by a processing device) a map interface that indicates a plurality of insurance policy locational coordinates, overlaying (e.g., by the processing device) via the map interface, at least one storm impact zone over the indications of the plurality of insurance policy locational coordinates, and causing (e.g., by the processing device), via the map interface, an outputting of an indication of a subset of the plurality of insurance policy locational coordinates that are determined to have been impacted by a weather event associated with the at least one storm impact zone. According to some embodiments, the at least one storm impact zone may be based on radar data. According to some embodiments, the plurality of insurance policy locational coordinates may comprise coordinates of insurance policy claims. According to some embodiments, the method may further comprise determining (e.g., by the processing device), based on the indication of the subset of the plurality of insurance policy locational coordinates that are determined to have been impacted by the weather event associated with the at least one storm impact zone, a total expected insurance exposure for an insurance company. According to some embodiments, the method may further comprise causing (e.g., by the processing device), via the map interface, an outputting of an indication of the total expected insurance exposure for the insurance company.

From the above description, it is clear that a number of technical problems arise in the implementation of embodiments. For example, one particular technical problem is how to relate weather data to locations of entities, such as buildings, for which an insurance claim is made.

As described above, one embodiment addresses this problem by providing a processing apparatus which is operable to receive and process both georeferenced weather data and georeferenced data for an entity which has suffered damage.

More particularly, as described above, the processing apparatus is operable to receive and process weather data such as, for example, NOAA NWS, NCDC, and/or National Severe Storms Laboratory (NSSL) data and/or other third-party (municipal or private) weather service data such as NEXt-Generation RADar (NEXRAD) data (e.g., S-band Doppler radar data in accordance with the IEEE Standard 521 (1984)), Terminal Doppler Weather Radar (TDWR) data, and/or weather metric, index, and/or algorithm data (e.g., Vertically Integrated Liquid (VIL) data, VIL density data, wind gust algorithm data, hail algorithm data, mesocyclone algorithm data, Tornado Vortex Signature (TVS) algorithm data, wind shear algorithm data, and/or Velocity Azimuth Display (VAD) Wind Profile (VWP) algorithm data. The weather data received by the processing apparatus may comprise raw data (e.g., radar and/or satellite data, such as radar maximum and/or minimum readings), pre-filtered and/or processed data (e.g., “cleansed”), and/or analyzed and/or derived data (e.g., algorithm results or outcomes such as wind speed, wind direction, hail size, hail type, maximum hail probability, hail duration, estimated cloud layer elevations (e.g., echo top), precipitation locations, durations, and/or accumulations, precipitation types, storm tracks, etc.). The weather data may comprise data from one or more of a variety of weather and/or weather related sensors such as satellite sensors (e.g., imagery or otherwise), storm surge and/or water level sensors (e.g., stream or river level or flow sensors), temperature sensors, etc. The weather data includes geolocation data for defining the geographical location and geographical extent of the weather event. This geolocation data may comprise, for example, data descriptive of one or more coordinates such as ‘x’, ‘y’, and/or ‘z’ coordinates, Global Positioning System (GPS) coordinates, Latitude and Longitude coordinates, easting and northing, etc.

The data relating to an entity that has suffered damage that is received and processed by the processing apparatus may comprise image data and geospatial data, such as GPS position data, recorded by a mobile telephone or an unmanned aerial vehicle, for example as described above with reference to FIG. 9. In this way, data defining the location of the image recording device at the time an image of damage was recorded is transmitted to the processing apparatus together with the image data. The processing apparatus is operable to process image data showing damage to an entity to determine a type of weather that may have caused the damage. The processing apparatus is configured to store the received weather data and entity data in a relational manner, for example as described above with reference to FIG. 5. The processing apparatus is operable to process the stored weather data and entity data to determine whether particular damage to an entity was likely caused by a weather event at the location of the entity. More particularly, the processing apparatus is configured to process the geospatially-referenced weather data for (i) the geographical area in which the entity that suffered the loss was located and (ii) a particular date or data range, to determine a probability that a particular weather event caused the damage suffered by the entity at that location. For example, in the case that the determined probability exceeds a predetermined threshold, the processing apparatus is configured to determine that a particular weather event is likely to have caused the damage. As explained above, differing threshold levels may be set for different types of damage and different types of weather events.

Furthermore, the processing apparatus is operable to process the stored weather data and entity data to provide a graphical display depicting a relationship between weather events and the location of at least one entity that has suffered damage on a particular date (or particular date range). Examples of such a graphical display are described above with reference to FIG. 6, FIG. 7 and FIG. 8. More particularly, as described above with reference to these figures, the processing apparatus is operable to process the stored data to generate and display a map of a geographical area in which one or more entities that have suffered damage are located, together with weather zones defining the geographical location and extent of weather events of different types and/or different severities for a given date or date range. Thus, as described above by way of example, the processing apparatus may display one or more primary weather severity zones indicating a certain likelihood (for example that a certain threshold probability has been exceeded) that weather having a first severity level occurred and/or caused damage in the indicated area(s). Similarly, the processing apparatus may display one or more secondary weather severity zones that indicate a certain likelihood that weather having a second severity level occurred and/or caused damage in the indicated area(s), as well as one or more tertiary weather severity zones that indicate a certain likelihood that weather having a third severity occurred and/or caused damage in the indicated area(s). Each of these weather severity zones may be included in a separate data layer such that individual layers may be turned on or off (that is, displayed or not displayed) for data visualization. Thus, referring to FIG. 7 by way of example, the processing apparatus may display a geographic area overlaid with a graphical representation of weather event-probability zones, in which each zone defines the geographical boundary that has been determined by the processing apparatus to have been exposed to a particular type and/or magnitude of weather event. The processing apparatus is operable to display a subset of the zones selected by a user (the subset containing one, or a plurality, of all of the zones). Furthermore, as shown for example in FIG. 8, the processing apparatus may process the stored data to generate a graphical display for a specific location of an entity overlaid with a set of data layers such that the different positions of the data layers represents different severities, types and/or times of weather events for that location.

It will therefore be understood that an embodiment provides the following:

1. A processing apparatus, comprising:

means for determining a locational coordinate of a weather-related loss associated with an insurance claim;

means for determining a date of the loss; and

means for determining, based on stored georeferenced weather data, a likelihood of weather on the date of the loss at the locational coordinate having caused the loss;

2. The processing apparatus of clause 1, wherein the means for determining the locational coordinate of a weather-related loss comprises means for receiving, from a remote mobile device, image data defining an image of damage associated with the loss and location data defining the location of the mobile device when the image was recorded;
3. The processing apparatus of clause 2, wherein the means for receiving image data and location data is operable to receive image data and GPS data transmitted from a mobile telephone;
4. The processing apparatus of clause 2 or clause 3, wherein:

the processing apparatus further comprises means for processing the received image data to determine the type of weather that caused the loss; and

the means for determining the likelihood of weather having caused the loss is operable to determine, based on the stored georeferenced weather data, a likelihood that weather of the determined type occurred at the locational coordinate on the date of the loss;

5. The processing apparatus of any preceding clause, further comprising means for generating graphical display data comprising a geographical area in which the locational coordinate of the weather-related loss is located and a plurality of weather zones overlaid on the geographical area;
6. The processing apparatus of clause 5, wherein the weather zones comprise zones defining the geographical extents of different types of weather that occurred on the date of the loss;
7. The processing apparatus of clause 5 or clause 6, wherein the weather zones comprise zones defining the geographical extents of different severities of weather of a particular type that occurred on the date of the loss;
8. The processing apparatus of any of clauses 5 to 7, wherein the weather zones comprise zones defining the geographical extents of weather of a particular type at different times;
9. The processing apparatus of any of clauses 5 to 8, wherein the means for generating the graphical display data is further operable to generate graphical display data comprising the geographical area and a selected subset of the weather zones;
10. A method performed by a processing apparatus, comprising:

determining a locational coordinate of a weather-related loss associated with an insurance claim;

determining a date of the loss; and

determining, based on stored georeferenced weather data, a likelihood of weather on the date of the loss at the locational coordinate having caused the loss;

11. The method apparatus of clause 10, wherein the process of determining the locational coordinate of a weather-related loss comprises receiving, from a remote mobile telephone, image data defining an image of damage associated with the loss and GPS data defining the location of the mobile device when the image was recorded;
12. The method of clause 11, further comprising processing the received image data to determine the type of weather that caused the loss, and wherein the process of determining the likelihood of weather having caused the loss comprises determining, based on the stored georeferenced weather data, a likelihood that weather of the determined type occurred at the locational coordinate on the date of the loss;
13. The method of any of clauses 10 to 12, further comprising generating graphical display data comprising a geographical area in which the locational coordinate of the weather-related loss is located and a plurality of weather zones overlaid on the geographical area;
14. The method of clause 13, wherein the weather zones comprise at least one of:

(a) zones defining the geographical extents of different types of weather that occurred on the date of the loss;

(b) zones defining the geographical extents of different severities of weather of a particular type that occurred on the data of the loss;

(c) zones defining the geographical extents of weather of a particular type at different times;

15. A computer program product, comprising a storage medium or a signal, carrying computer program instructions to program a programmable processing apparatus to become operable to perform a method as set out in at least one of clauses 10 to 14.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A system, comprising:
a processing device; and
a memory device in communication with the processing device, the memory device storing instructions that when executed by the processing device result in:
determining (i) a locational coordinate of a weather-related loss associated with an insurance claim and (ii) a date of the loss;
determining, based on stored georeferenced weather data, a likelihood of weather on the date of loss at the locational coordinate having caused the loss; and
determining, based on an application of stored claim handling rules to the determined likelihood of weather on the date of loss at the locational coordinate having caused the loss, whether to pay the claim.

2. The system of claim 1, wherein the instructions, when executed by the processing device, further result in:
causing, in the case that it is determined that the claim should be paid, a payment of the claim.

3. The system of claim 1, wherein the determining of the locational coordinate of the weather-related loss associated with the insurance claim, comprises:
receiving, from a remote mobile device, data descriptive of the locational coordinate.

4. The system of claim 3, wherein the data descriptive of the locational coordinate comprises GPS data identifying a location of the remote mobile device.

5. The system of claim 1, wherein the instructions, when executed by the processing device, further result in:
receiving, from a remote mobile device, data descriptive of the loss.

6. The system of claim 5, wherein the data descriptive of the loss comprises an image of damage associated with the loss.

7. The system of claim 5, wherein the instructions, when executed by the processing device, further result in:
determining, based on the data descriptive of the loss received from the remote mobile device, a type of peril that caused the loss.

8. The system of claim 7, wherein the type of peril comprises one or more of: (i) hail damage, (ii) wind damage, (iii) water damage, and (iv) lightning strike damage.

9. The system of claim 7, wherein the determining of the likelihood of the weather on the date of loss at the locational coordinate having caused the loss, comprises:
determining, based on the stored georeferenced weather data and the determined type of the loss, a likelihood that a type of weather associated with the type of the loss occurred at the locational coordinate on the date of the loss.

10. The system of claim 1, wherein the determining of the date of the weather-related loss associated with the insurance claim, comprises:
receiving an indication of the date of loss from a customer associated with the insurance claim.

11. The system of claim 10, wherein the determining of the likelihood of the weather on the date of loss at the locational coordinate having caused the loss, comprises:
determining that no weather event that occurred on the date of loss at the locational coordinate of the loss exceeds a predetermined magnitude threshold;
identifying a different date in the past where a weather event exceeding the predetermined magnitude did occur at the locational coordinate; and
determining whether an insurance policy associated with the insurance claim was in force on the different date.

12. The system of claim 11, wherein the instructions, when executed by the processing device, further result in:
substituting, in the case that it is determined that the insurance policy was in force on the different date, the likelihood of weather on the date of loss at the locational coordinate having caused the loss with a likelihood that the weather event caused the loss on the different date.

13. The system of claim 1, wherein the locational coordinate comprises a GPS coordinate.

14. The system of claim 1, wherein the locational coordinate comprises a geospatial identifier that is unique to a specific insurance customer.

15. The system of claim 1, wherein the instructions, when executed by the processing device, further result in:
causing an outputting of an indication of the determination of whether to pay the claim.

16. A system, comprising:
a processing device; and
a memory device in communication with the processing device, the memory device storing instructions that when executed by the processing device result in:
providing a map interface that indicates a plurality of insurance policy locational coordinates;
overlaying, via the map interface, at least one storm impact zone over the indications of the plurality of insurance policy locational coordinates; and
causing, via the map interface, an outputting of an indication of a subset of the plurality of insurance policy locational coordinates that are determined to have been impacted by a weather event associated with the at least one storm impact zone.

17. The system of claim 16, wherein the at least one storm impact zone is based on radar data.

18. The system of claim 16, wherein the plurality of insurance policy locational coordinates comprise coordinates of insurance policy claims.

19. The method of claim 16, wherein the instructions, when executed by the processing device, further result in:
determining, based on the indication of the subset of the plurality of insurance policy locational coordinates that are determined to have been impacted by the weather event associated with the at least one storm impact zone, a total expected insurance exposure for an insurance company associated with the weather event.

20. The method of claim 19, wherein the instructions, when executed by the processing device, further result in:
causing, via the map interface, an outputting of an indication of the total expected insurance exposure for the insurance company associated with the weather event.
